(19) United States
(12) Patent Application Publication
(10) Pub. No.: US 2025/0260633 A1
(43) Pub. Date: Aug. 14, 2025

(54) ENFORCEMENT RESULT REPORTING METHOD AND RECEIVING METHOD, TERMINAL, AND NETWORK-SIDE DEVICE

(71) Applicant: VIVO MOBILE COMMUNICATION CO., LTD., Dongguan (CN)

(72) Inventors: Huazhang LV, Dongguan (CN); Sihan CHENG, Dongguan (CN)

(21) Appl. No.: 19/189,305

(22) Filed: Apr. 25, 2025

Related U.S. Application Data
(63) Continuation of application No. PCT/CN2023/125873, filed on Oct. 23, 2023.

(30) Foreign Application Priority Data
Oct. 26, 2022 (CN) 202211321226.2
Jan. 6, 2023 (CN) 202310021146.3

(51) Int. Cl. H04L 43/062; H04L 43/067

(52) U.S. Cl. CPC H04L 43/062; H04L 43/067

(57) ABSTRACT

This application discloses an enforcement result reporting method and receiving method, a terminal, and a network-side device. The enforcement result reporting method includes: receiving, by a terminal, first information sent by a network-side device, where the first information is a reporting indication, and the first information in carried by at least one URSP rule; and reporting, by the terminal, an enforcement result of a URSP rule according to the first information; where the reporting, by the terminal, an enforcement result of a URSP rule according to the first information includes: in a case that the terminal receives a URSP rule carrying the first information, after the terminal completes enforcement of the URSP rule carrying the first information, reporting, by the terminal, an enforcement result of the URSP rule.

### CROSS-REFERENCE TO RELATED APPLICATIONS

This application is a continuation of International Patent Application No. PCT/CN2023/125873, filed on Oct. 23, 2023, which claims priority to Chinese Patent Application No. 202211321226.2, filed in China on Oct. 26, 2022, and priority to Chinese Patent Application No. 202310021146.3, filed in China on Jan. 6, 2023, all of which are incorporated herein by reference in their entireties.

### TECHNICAL FIELD

This application belongs to the field of communication technologies, and specifically relates to an enforcement result reporting method and receiving method, a terminal, and a network-side device.

### BACKGROUND

A UE Route Selection Policy (URSP) rule is a UE policy. A terminal configures Application (APP) traffic to a specific Protocol Data Unit (PDU) session (session) according to the URSP rule. Currently, when the terminal enforces the URSP rule for an APP or APP traffic (application traffic) once, the terminal needs to report an enforcement result of the URSP rule to a network-side device once.

### SUMMARY

Embodiments of this application provide an enforcement result reporting method and receiving method, a terminal, and a network-side device.

According to a first aspect, an enforcement result reporting method is provided, including:
receiving, by a terminal, first information sent by a network-side device; and reporting, by the terminal, an enforcement result of a URSP rule according to the first information;
where the first information is used to indicate at least one of the following:
reporting content or a reporting manner;
where in a case that the first information indicates the reporting content, the terminal reports an enforcement result of one or more specific URSP rules each time, and/or the terminal reports each time an enforcement result of enforcing a URSP rule for a specific application APP or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

According to a second aspect, an enforcement result receiving method is provided, including:
sending, by a network-side device, first information to a terminal; and
receiving, by the network-side device, an enforcement result of a UE route selection policy URSP rule reported by the terminal;
where the first information is used to indicate at least one of the following:
reporting content or a reporting manner;
where in a case that the first information indicates the reporting content, the terminal reports an enforcement result of one or more specific URSP rules each time, and/or the terminal reports each time an enforcement result of enforcing a URSP rule for a specific application APP or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

According to a third aspect, an enforcement result reporting apparatus is provided, including:
a receiving module, configured to receive first information sent by a network-side device; and
a reporting module, configured to report an enforcement result of a UE route selection policy URSP rule according to the first information;
where the first information is used to indicate at least one of the following:
reporting content or a reporting manner;
where in a case that the first information indicates the reporting content, the terminal reports an enforcement result of one or more specific URSP rules each time, and/or the terminal reports each time an enforcement result of enforcing a URSP rule for a specific application APP or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

According to a fourth aspect, an enforcement result receiving apparatus is provided, including:
a sending module, configured to send first information to a terminal; and
a receiving module, configured to receive an enforcement result of a UE route selection policy URSP rule reported by the terminal;
where the first information is used to indicate at least one of the following:
reporting content or a reporting manner;
where in a case that the first information indicates the reporting content, the terminal reports an enforcement result of one or more specific URSP rules each time, and/or the terminal reports each time an enforcement result of enforcing a URSP rule for a specific application APP or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

According to a fifth aspect, a terminal is provided. The terminal includes a processor and a memory, the memory stores a program or instructions capable of running on the processor, and the program or the instructions are executed by the processor to implement the steps of the enforcement result reporting method provided in embodiments of this application.

According to a sixth aspect, a terminal is provided, including a processor and a communication interface, where the communication interface is configured to receive first information sent by a network-side device; and report an enforcement result of a UE route selection policy URSP rule according to the first information; where the first information is used to indicate at least one of the following: reporting content or a reporting manner; where in a case that the first information indicates the reporting content, the terminal reports an enforcement result of one or more specific URSP rules each time, and/or the terminal reports each time an enforcement result of enforcing a URSP rule for a specific application APP or APP traffic; or in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

According to a seventh aspect, a network-side device is provided, where the network-side device includes a processor and a memory, the memory stores a program or instructions capable of running on the processor, and the program or the instructions are executed by the processor to implement the steps of the enforcement result receiving method provided in embodiments of this application.

According to an eighth aspect, a network-side device is provided, including a processor and a communication interface, where the communication interface is configured to: send first information to a terminal; and receive an enforcement result of a UE route selection policy URSP rule reported by the terminal, where the first information is used to indicate at least one of the following: reporting content or a reporting manner; where in a case that the first information indicates the reporting content, the terminal reports an enforcement result of one or more specific URSP rules each time, and/or the terminal reports each time an enforcement result of enforcing a URSP rule for a specific application APP or APP traffic; or in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

According to a ninth aspect, an enforcement result reporting system is provided, including a terminal and a network-side device, where the terminal may be configured to perform the steps of the enforcement result reporting method provided in embodiments of this application, and the network-side device may be configured to perform the steps of the enforcement result receiving method provided in embodiments of this application.

According to a tenth aspect, a readable storage medium is provided, where a program or instructions are stored in the readable storage medium, and the program or the instructions are executed by a processor to implement the steps of the enforcement result reporting method provided in embodiments of this application, or implement the steps of the enforcement result receiving method provided in embodiments of this application.

According to an eleventh aspect, a chip is provided, where the chip includes a processor and a communication interface, the communication interface is coupled to the processor, and the processor is configured to run a program or instructions to implement the enforcement result reporting method provided in embodiments of this application, or implement the enforcement result receiving method provided in embodiments of this application.

According to a twelfth aspect, a computer program/program product is provided, where the computer program/program product is stored in a storage medium, and the computer program/program product is executed by at least one processor to implement the steps of the enforcement result reporting method provided in embodiments of this application, or the computer program/program product is executed by at least one processor to implement the steps of the enforcement result receiving method provided in embodiments of this application.

In embodiments of this application, a terminal receives first information sent by a network-side device, and the terminal reports an enforcement result of a UE route selection policy URSP rule according to the first information; where the first information is used to indicate at least one of the following: reporting content or a reporting manner; where in a case that the first information indicates the reporting content, the terminal reports an enforcement result of one or more specific URSP rules each time, and/or the terminal reports each time an enforcement result of enforcing a URSP rule for a specific application APP or APP traffic; or in a case that the first information indicates the reporting manner, the terminal reports each time enforcement results of a URSP rule enforced by the terminal for a plurality of times, or the terminal reports each time an enforcement result of a URSP rule enforced by the terminal in one reporting period. In this way, the terminal may report, according to the first information, only an enforcement result of a specific URSP rule and/or of enforcing a URSP rule for a specific application APP or APP traffic, or report, at a time, enforcement results of a URSP rule enforced by the terminal for a plurality of times or enforced in a reporting period.

### BRIEF DESCRIPTION OF DRAWINGS

FIG. 1 is a block diagram of a wireless communication system applicable to an embodiment of this application;

FIG. 2 is a flowchart of an enforcement result reporting method according to an embodiment of this application;

FIG. 3 is a flowchart of an enforcement result receiving method according to an embodiment of this application;

FIG. 4 is a schematic diagram of sending first information according to an embodiment of this application;

FIG. 5 is another schematic diagram of sending first information according to an embodiment of this application;

FIG. 6 is another schematic diagram of sending first information according to an embodiment of this application;

FIG. 7 is another schematic diagram of sending first information according to an embodiment of this application;

FIG. 8 is another schematic diagram of sending first information according to an embodiment of this application;

FIG. 9 is a structural diagram of an enforcement result reporting apparatus according to an embodiment of this application;

FIG. 10 is a structural diagram of an enforcement result receiving apparatus according to an embodiment of this application;

FIG. 11 is a structural diagram of a communication device according to an embodiment of this application;

FIG. 12 is a structural diagram of a terminal according to an embodiment of this application; and

FIG. 13 is a structural diagram of a network-side device according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” generally represents an “or” relationship between associated objects.

It should be noted that, a technology described in embodiments of this application is not limited to a Long Term Evolution (LTE)/LTE-Advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” are often used interchangeably in the embodiments of this application. A technology described may be used for the systems and radio technologies described above, as well as other systems and radio technologies. A New Radio (NR) system is described in the following descriptions for illustrative purposes, and NR terms are used in most of the following descriptions. However, these technologies can also be applied to applications such as a 6th Generation (6G) communication system other than NR system applications.

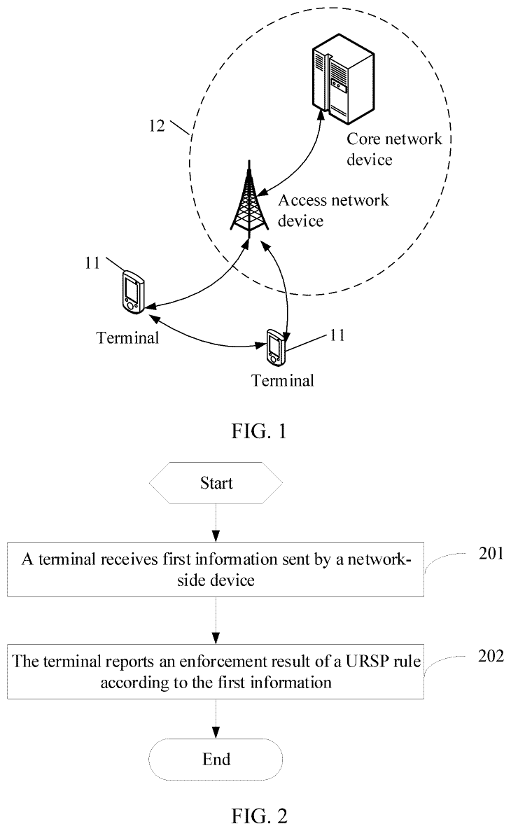

FIG. 1 is a block diagram of a wireless communication system applicable to an embodiment of this application. The wireless communication system includes a terminal 11 and a network-side device 12. The terminal 11 may be a mobile phone, a tablet personal computer, a laptop computer or referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a laundry machine, or a furniture), a gaming console, a Personal Computer (PC), a teller machine, a self-service machine, or another terminal-side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network-side device 12 may include an access network device or a core network device. The access network device may also be referred to as a wireless access network device, a radio access network (Radio Access Network, RAN), a radio access network function, or a radio access network unit. The access network device may include a base station, a Wireless Local Area Network (WLAN) access point, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. Provided that same technical effects are achieved, the base station is not limited to a specific technical term. It should be noted that in embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), or the like. It should be noted that in the embodiments of this application, only a core network device in the NR system is used as an example for description, and a specific type of the core network device is not limited.

In embodiments of this application, the PCF includes the following: an Access and Mobility Management PCF (AM-PCF), a Session Management PCF (SM-PCF), and a User Equipment PCF (UE-PCF). Embodiments of this application set no specific limitation.

In embodiments of this application, the terminal includes a User Equipment Operating System (UE OS) and a UE chip (UE modem or UE module). The terminal may further include an application layer of the terminal, for example, an application client on the terminal and an application program on the terminal.

In embodiments of this application, the terminal receives first information sent by a network-side device, and the network-side device may be any one of an access network device or a core network device. In embodiments of this application, as an example, the terminal receives the first information from at least one of the following network-side devices: an AMF, an AM-PCF, a PCF, a UE-PCF, or the like, but a network element type is not limited.

In embodiments of this application, the terminal reports an enforcement result of a URSP rule to a network side, and the network-side device may be any one of an access network device or a core network device. In embodiments of this application, as an example, the terminal reports an enforcement result of a URSP rule to at least one of the following network-side devices: an AMF, an AM-PCF, a PCF, a UE-PCF, or the like, but a network element type is not limited.

In some embodiments, the URSP rule is a policy defined by 3GPP for sending by the terminal. The terminal may match traffic of an APP to a specific PDU session according to the URSP rule.

For example, when APPs on the terminal have traffic that needs to be sent to a server end, the APPs may send APP traffic features to the terminal. There are many types of traffic features, such as a destination IP address and a Fully Qualified Domain Name (FQDN). Then, the terminal matches the URSP rule in the terminal according to the APP traffic features. In the URSP rule, specified traffic descriptions and/or features may include content shown in the following Table 1-1:

TABLE 1-1

| | |
|---|---|
| Traffic descriptor | This part defines the Traffic descriptor components for the URSP rule |
| (Traffic descriptor) | (This part defines the Traffic descriptor components for the URSP |
| | rule). |
| APP descriptors | It consists of an operating system identifier (OSID) and an operating |
| (Application | system APP identifier (OSAPPID) (It consists of OSId and |
| descriptors) | OSAppId(s)). |
| IP descriptors (IP | Destination IP 3 tuple (Destination IP 3 tuple(s)), IP address or IPV6 |
| descriptors) | network prefix, port number, protocol ID of the protocol above IP (IP |
| | address or IPv6 network prefix, port number, protocol ID of the |
| | protocol above IP). |
| Domain descriptors | FQDN(s) or a regular expression which are used as a domain name |
| (Domain descriptors) | matching criteria (FQDN(s) or a regular expression which are used as |
| | a domain name matching criteria) |
| Non-IP descriptors | Descriptor(s) for destination information of non-IP traffic |
| (Non-IP descriptors) | (Descriptor(s) for destination information of non-IP traffic) |
| Data network name | This is matched against the DNN information provided by the |
| (Data Network Name, | application (This is matched against the DNN information provided |
| DNN) | by the application). |
| | Used to describe which data network is accessed by or connected to |
| | by the APP traffic |
| Connection capabilities | This is matched against the information provided by a UE application |
| (Connection | when it requests a network connection with certain capabilities (This |
| Capabilities) | is matched against the information provided by a UE application when |
| | it requests a network connection with certain capabilities.) |
| | Similar to “ims”, “mms”, and “internet” (IP Multimedia Subsystem, IP |
| | multimedia subsystem; Multimedia Messaging Service, multimedia |
| | messaging service) |

For example, in the second item in the foregoing Table 1-1, the APP (on the terminal) may send an IP description to describe traffic of the APP, for example, a destination IP 3 tuple. This indicates that the traffic of the APP is traffic that needs to be sent to a destination IP=10.1.1.1 and a port number=80. Then, if this traffic descriptor exactly exists in the URSP rule of the terminal, it indicates that the traffic of the APP can be matched to a URSP rule, that is, the traffic can be configured into a PDU session by using a rule in the terminal.

After the URSP rule matches the traffic of the APP, the next step is to choose to use which PDU session to send the traffic of the APP.

It should be noted that Table 1-1 is only one example for description.

In some implementations, one traffic descriptor may have a plurality of Route Selection Descriptors (RSDs), and one RSD may have one or more Route Selection Components (RSCs), where each RSD represents or describes a set of attributes of one PDU session or a parameter of a PDU session. For example, when the APP traffic matches a group of traffic descriptors of a destination IP=10.1.1.1 and a port number=80, the following several RSDs exist in the group of traffic descriptors:
RSD precedence (RSD precedence)=1:
Single network slice selection assistance information (Single Network Slice Selection Assistance Information, S-NSSAI)-a
Non-3GPPAccess (Non-3GPPAccess) (wifi, WLAN);
RSD precedence=2:
S-NSSAI-a
3GPP Access (4G, 5G)
DNN=Internet
Session and Service Continuity (SSC) mode=3.

For example, a characteristic of a PDU session corresponding to RSD1 is S-NSSAI=S-NSSAI-a, and non-3GPP access in used. That is, after the terminal selects the RSD for application traffic, the application traffic is matched or configured to be carried in such a PDU session, that is, the PDU session uses non-3GPP access and uses an S-NSSAI-a slice.

A URSP rule may be shown in Table 1-2:

TABLE 1-2
Example URSP rules (Example URSP rules)

| | |
|---|---|
| Rule precedence (Rule | Route selection descriptor precedence (Route Selection |
| Precedence) = 1 | Descriptor Precedence) = 1 |
| Traffic Descriptor: APP descriptor | Network slice selection (Network Slice Selection): |
| (Application descriptor) = App1 | S-NSSAI-a |
| | SSC mode selection (SSC Mode Selection): SSC Mode 3 |
| | DNN selection (DNN Selection): internet |
| | Access type precedence (Access Type preference): 3GPP |
| | access |
| Rule Precedence = 2 | Route Selection Descriptor Precedence = 1 |
| Traffic Descriptor: Application | Network Slice Selection: S-NSSAI-a |
| descriptor = App2 | Access Type preference: Non-3GPP access |
| | Route Selection Descriptor Precedence = 2 |
| | Non-seamless offload indication (Non-seamless Offload |
| | indication): Permitted (Permitted) (WLAN SSID-a) |
| Match all (Match all) | Default PDU session. |

In some embodiments, an enforcement result or an enforcement status of URSP rules (URSP rules) refers to a URSP rule enforced by a terminal for an APP or traffic of an APP (an APP on the terminal), for example, a URSP rule (including a traffic descriptor or an RSD) finally used for the APP or the traffic of the APP. In addition, the enforcement result or the enforcement status may further include parameters or attributes of a final PDU session carrying the APP or the traffic of the APP after the URSP rule is enforced, such as an access manner, an SSC mode, a DNN, a slice, and a PDU session type. The foregoing describes enforcement results or enforcement statuses of the URSP rule.

An enforced URSP rule refers to a traffic descriptor (traffic descriptor) that is used for the APP (on the terminal) or the APP traffic (on the terminal), or matched for the APP (on the terminal) or the APP traffic (on the terminal), and/or a route selection descriptor (route selection descriptor, RSD) in the used or matched traffic descriptor.

The terminal may report the enforcement result of the URSP rule for the following purposes:

After designing and delivering a URSP rule to a terminal, an operator wishes to know which rule is finally enforced in the terminal for traffic of some APPs. Then, the operator may adjust, according to a feedback of an enforcement result, a URSP rule whose design is improper.

In addition, it can be learned from the foregoing description that, according to different internal designs of the terminal or different URSP rules sent by a network, final enforcement results of the URSP rules are different for different applications. Even for a same APP, the network may send a plurality of RSDs of different precedences. Therefore, the final enforcement results of the URSP rules may be different. This is why the network wants to obtain the enforcement results of the URSP rules of the terminal.

With reference to the accompanying drawings, the following describes in detail, by using some embodiments and application scenarios, an enforcement result reporting method and receiving method, a terminal, and a network-side device that are provided in embodiments of this application.

Referring to FIG. 2, FIG. 2 is a flowchart of an enforcement result reporting method according to an embodiment of this application. As shown in FIG. 2, the method includes the following steps:

Step 201: A terminal receives first information sent by a network-side device.

Step 202: The terminal reports an enforcement result of a URSP rule according to the first information.

The network-side device may send the first information to the terminal by using at least one of the following:
a registration accept (Registration accept) message;
a downlink NAS message (DL NAS message);
a PDU session establishment accept (PDU session establishment accept) message; or a PDU session modification accept (PDU session modification accept) message.

The first information is used to indicate at least one of the following:
reporting content or a reporting manner;
where in a case that the first information indicates the reporting content, the terminal reports an enforcement result of one or more specific URSP rules each time, and/or the terminal reports each time an enforcement result of enforcing a URSP rule for a specific APP or APP traffic.

The reporting content may specify content in the reported enforcement result of the URSP rule.

In a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

The reporting manner may specify a condition according to which the enforcement result of the URSP rule is reported or a condition that needs to be met before the enforcement result of the URSP rule can be reported.

The first information is indication information used to indicate the terminal to report the enforcement result of the URSP rule according to at least one of the foregoing reporting content or reporting manner.

The reporting content may indicate a specific URSP rule, for example, one or more specific URSP rules, a URSP rule corresponding to a specific APP, a URSP rule at a specific time, or a URSP rule at a specific terminal location. In this way, based on the reporting content, the terminal needs to report only an enforcement result of one or more specific URSP rules, thereby reducing transmission overheads.

The reporting manner may indicate reporting each time enforcement results of a URSP rule enforced for a plurality of times, so that reporting does not need to be performed once for each URSP rule, thereby reducing transmission overheads.

In some implementations, the first information may be sent by a PCF to the terminal. For example, the PCF sends the first information to the terminal by using an AMF, and the first information may be carried in a downlink NAS message.

For example, the PCF sends the first information to the AMF by using at least one of the following:
a UE policy control create response (Npcf_UEPolicyControl_Create response) message;
a UE policy control update response (Npcf_UEPolicyControl_Update response) message; or
a message transfer signaling (Namf_Communication_N1N2MessageTransfer) message.

Then, the AMF sends the first information to the terminal by using at least one of the following:
a registration accept (Registration accept) message;
a downlink NAS message (DL NAS message);
a PDU session establishment accept (PDU session establishment accept) message; or
a PDU session modification accept (PDU session modification accept) message.

That the terminal reports the enforcement result of the URSP rule according to the first information may be that the terminal reports the enforcement result of the URSP rule to the network-side device according to the first information, for example, reports the enforcement result of the URSP rule to an SMF, or reports the enforcement result of the URSP rule to a PCF.

For example, the terminal may report the enforcement result of the URSP rule by using at least one of the following (the enforcement result is first reported to the AMF, and then reported to the PCF (including an AM-PCF, a UE-PCF, and the like)):
a registration request (Registration request) message;
an uplink NAS message (UL NAS message) message;
a PDU session establishment request (PDU session establishment request) message; or a PDU session modification request (PDU session modification request) message.

Then, the AMF may send the enforcement result of the URSP rule to the PCF by using at least one of the following:

The AMF directly sends the enforcement result of the URSP rule to the PCF (the AM-PCF or the UE-PCF) by using at least one of the following:
a UE policy control create or update request (Npcf_UEPolicyControl Create/Update request).

The AMF may further first send the enforcement result of the URSP rule to the SMF, then the SMF sends the enforcement result of the URSP rule to an SM-PCF, and then the SM-PCF sends the enforcement result of the URSP rule to the PCF (the AM-PCF or the UE-PCF). The method is as follows:

The AMF sends the enforcement result of the URSP rule to the SMF: a Nsmf_PDUSession_CreateSMContext Request or a Nsmf_PDUSession_UpdateSMContext Request, PDU session create/update session management context request.

Then, the SMF sends the enforcement result of the URSP rule to the SM-PCF: a Npcf_SMPolicyControl Create/Update request, session management policy control create or update request.

Then, the SM-PCF sends the enforcement result of the URSP rule to the PCF (the AM-PCF or the UE-PCF): a UE policy control create or update request (Npcf_UEPolicyControl Create/Update request).

In this embodiment of this application, according to the foregoing steps, the terminal may report, according to the first information, only an enforcement result of a specific URSP rule and/or of enforcing a URSP rule for a specific application APP or APP traffic, or report, at a time, enforcement results of a URSP rule enforced by the terminal for a plurality of times or enforced in a reporting period, thereby reducing transmission overheads of the terminal.

In an optional implementation, the enforcement result of the URSP rule refers to a URSP rule enforced or used by the terminal for at least one APP or traffic of at least one APP.

In an implementation, after the terminal separately enforces a URSP rule for a plurality of APPs on the terminal, the terminal needs to report all the enforcement results to the network side. The terminal may also select, according to the first information, what content to report and how to report the content to the network side.

The enforcement result may indicate a URSP rule enforced or used by the terminal for at least one APP or traffic of at least one APP. Therefore, the network-side device may learn of, by using the enforcement result, the URSP rule enforced or used by the terminal for the APP or the traffic of the APP.

In an optional implementation, the reporting content includes at least one of the following:
a first URSP rule set, where the first URSP rule set includes at least one URSP rule;
a first APP set, where the first APP set includes at least one APP;
at least one time period; or
at least one terminal location.

The first URSP rule set may be one or more URSP rule sets, and each URSP rule set includes at least one URSP rule. The first URSP rule may be a URSP rule cared about by the network-side device, and the first URSP rule set may be indicated by using an APP identifier, a URSP rule identifier, or the like.

In an implementation, the network side indicates, by using the first information, the terminal to send enforcement results of only several specific URSP rules to the network side. That is, only after the terminal enforces the several specific URSP rules for some APP or APP traffic, enforcement results of the URSP rules are generated. In this case, the terminal reports the enforcement results of the URSP rules. For those URSP rules not in the first URSP rule set, the terminal does not report results even if they are enforced. The advantage is that the network only cares about enforcement results of some specific URSP rules, and not enforcement results of all URSP rules in the terminal need to be reported, so as to reduce transmission overheads.

The first URSP rule set may be used to indicate the terminal to report only an enforcement result of a URSP rule in the URSP rule set, thereby reducing transmission overheads.

In some implementations, the first information may indicate the at least one URSP rule in the first URSP rule set by carrying at least one of the following:
a URSP rule identifier (URSP rule ID), a traffic descriptor (Traffic descriptor), a traffic descriptor precedence (Traffic descriptor precedence), a route selection descriptor (Route Selection Descriptor), or a route selection descriptor precedence (Route Selection Descriptor precedence).

The foregoing at least one item may be understood as indicating the at least one URSP rule in the first URSP rule set by carrying the foregoing one or more items. For example, by carrying Traffic descriptor+Route Selection Descriptor, it is determined to use a traffic descriptor and an RSD. For another example, by using Traffic descriptor precedence+Route Selection Descriptor precedence, it is determined to use a traffic descriptor and an RSD. For another example, the first information directly carries an ID of a URSP rule, so as to indicate the terminal to report a result after the rule is used.

The first APP set may be one or more APP sets. In this way, the first APP set may be used to indicate the terminal to report only an enforcement result of a URSP rule enforced or used for an APP or APP traffic in the APP set, thereby reducing transmission overheads. For example, the network-side device indicates the terminal to report only a URSP rule that is used for the first APP set and that is cared about.

In an implementation, the network side may indicate, in the first information, the terminal that the terminal can report an enforcement result only after the terminal uses a URSP rule for some specific APPs or traffic of APPs. For example, the first information may provide one or more APP identifiers. When the terminal uses a URSP rule for an application or application traffic on a terminal corresponding to these APP IDs, the terminal sends an enforcement result of the URSP rule to the network side. For another application, even if the terminal enforces the URSP rule, the terminal does not report an enforcement result, so as to reduce transmission overheads.

In some implementations, the first information may indicate the at least one APP in the first APP set by carrying at least one of the following:
an APP identifier, an Application Operating System Identifier (APP OSID), a source address or a source port number of an APP, a destination address or a destination port number accessed by an APP, a Fully Qualified Domain Name (FQDN) used or requested by an APP, or a Data Network Name (DNN) used or requested by an APP.

The APP identifier, the APP OS ID, and the like may identify an application on the terminal. The source address or the source port number of an APP, the destination address or the destination port number accessed by an APP, and the like may be used to identify a traffic feature of an application on the terminal. The FQDN used or requested by an APP or the DNN used or requested by an APP may be used to identify some specific applications on the terminal. For example, only an application of company A on the terminal uses a domain name: AAA.com. Alternatively, only an application of company B on the terminal uniquely requests to access a data network of local.BBB.com.

The at least one time period is one or more specific time periods, for example, 7 to 10 p.m. The at least one time period may be used to enable the terminal to report only an enforcement result of a URSP rule enforced by the terminal in the time period, thereby reducing transmission overheads.

In some implementations, the first information may indicate the at least one time period by carrying time information.

For example, if the network side provides a time interval, the terminal reports only an enforcement result of enforcing a URSP rule in the current time, and the time period may be referred to as a time window (Time Window). Only in the time window, the terminal reports the enforcement result of enforcing the URSP rule. For example, the network indicates the terminal to report the enforcement result of the URSP rule only after enforcing the URSP rule from 9 a.m. to 10 a.m. However, the enforcement result of the URSP rule does not need to be reported at a time beyond this time range. In this way, the network only cares about an enforcement result of a URSP rule in a specific time period, but does not care about another time period.

The at least one terminal location may be one or more cell locations, or may be one or more physical location areas, or one or more Areas of Interest (AOI, also referred to as locations of interest). For example, the network indicates the terminal to report the enforcement result of the URSP rule only after the URSP rule is enforced in an area B of a province A. In this way, the network can obtain the enforcement result of the URSP rule in some areas of interest. The network side does not care about another location.

The location information or the terminal location indicated in the first information includes at least one of the following:
a cell ID (Cell ID);
a tracking area ID (tracking area ID, TAI);
an area of interest (Area of interest), that is, a set of a plurality of terminal locations;
a location of application (Location of application); or
a data network access identifier (data network Access Identifier, DNAI).

By using the foregoing one terminal location, the terminal only needs to report an enforcement result of the URSP rule enforced by the terminal at the terminal location, thereby reducing transmission overheads.

In some implementations, the first information indicates the at least one terminal location by carrying at least one of the following:
terminal location information and AOI information.

The terminal location information may be criteria location information (Location Criteria). The enforcement result of enforcing the URSP rule can be reported only when the terminal meets a current location.

The AOI information may be a cell identity or a tracking area identity (Tracking Area Identity, TAI).

Optionally, the reporting, by the terminal, an enforcement result of a URSP rule according to the first information includes at least one of the following:
in a case that the reporting content includes the first URSP rule set, after the terminal enforces a URSP rule in the first URSP rule set, reporting, by the terminal, an enforcement result of the URSP rule;
in a case that the reporting content includes the first APP set, after the terminal enforces a URSP rule for an APP or APP traffic that belongs to the first APP set, reporting, by the terminal, an enforcement result of the URSP rule;
in a case that the reporting content includes the at least one time period, after the terminal enforces a URSP rule within a time indicated by the at least one time period, reporting, by the terminal, an enforcement result of the URSP rule; or
in a case that the reporting content includes the at least one terminal location, after the terminal enforces a URSP rule at a terminal location in the at least one terminal location, reporting, by the terminal, an enforcement result of the URSP rule.

After the terminal enforces the URSP rule in the first URSP rule set, that the terminal reports the enforcement result of the URSP rule may be: reporting an enforcement result of one URSP rule in the first URSP rule set each time the URSP rule is enforced.

After the terminal enforces the URSP rule for the APP or the APP traffic that belongs to the first APP set, that the terminal reports the enforcement result of the URSP rule may be: each time after a URSP rule is enforced for the APP or the APP traffic in the first APP set, the terminal reports the enforcement result of the URSP rule.

After the terminal enforces the URSP rule within the time indicated by the at least one time period, that the terminal reports the enforcement result of the URSP rule may be reporting an enforcement result of one URSP rule each time the URSP rule is enforced within the time period.

After the terminal enforces the URSP rule at the terminal location in the at least one terminal location, that the terminal reports the enforcement result of the URSP rule may be reporting an enforcement result of one URSP rule each time the URSP rule is enforced at the terminal location.

In this implementation, transmission overheads of the terminal may be reduced by using the foregoing provided reporting manner.

In an optional implementation, the first information is carried in at least one of the following:
at least one URSP rule; or
a policy section identifier (policy section ID, PSI) corresponding to at least one URSP rule.

The first information being carried in the at least one URSP rule may be adding the first information into the at least one URSP rule, where the first information may be an identifier, a bit, a field, or the like. An implementation may be shown in Table 2. Table 2 shows that a reporting indication is carried in a traffic descriptor of a URSP rule. Table 3 shows that a reporting indication is carried in an RSD of the traffic descriptor of the URSP rule.

TABLE 2

| | |
|---|---|
| Traffic descriptor | This part defines the Traffic descriptor components for the URSP rule |
| | (This part defines the Traffic descriptor components for the URSP |
| | rule). |
| Application descriptors | It consists of OSID and OSAPPID (It consists of OSId and OSAppId |
| Reporting indication | (s) |
| IP descriptors | Destination IP 3 tuple (Destination IP 3 tuple(s)), IP address or IPv6 |
| Reporting indication | network prefix, port number, protocol ID of the protocol above IP (IP |
| | address or IPv6 network prefix, port number, protocol ID of the |
| | protocol above IP). |

The reporting indication is the first information.

In this implementation, the URSP rule carrying the first information is a URSP rule indicated by the first information, that is, a specific URSP rule that the terminal needs to report.

That is, when the network side delivers the URSP rule, a reporting indication may be carried in the traffic descriptor or the RSD of the URSP rule. That is, if the terminal uses this rule for an APP or APP traffic, the terminal needs to report a use result. In this way, the network is prevented from sending additional indication information to the terminal. When the terminal receives the URSP rule, the URSP rule internally directly indicates that an enforcement result needs to be reported after the rule is used.

As described in Table 3, the RSD in the traffic descriptor of the URSP rule includes a reporting indication. After the terminal uses the URSP rule in which the RSD is located, the terminal reports the enforcement result.

TABLE 3
Example URSP rules

| | |
|---|---|
| Rule Precedence = 1 | Route Selection Descriptor Precedence = 1 |
| Traffic Descriptor: | Network Slice Selection: S-NSSAI-a |
| Application descriptor = | SSC Mode Selection: SSC Mode 3 |
| App1 | DNN Selection: internet |
| Reporting indication | Access Type preference: 3GPP access |

In an implementation, that the first information is carried in a PSI corresponding to at least one URSP rule may be that a URSP rule saved in or associated with a PSI carrying the first information is a URSP rule indicated by the first information, that is, a specific URSP rule that the terminal needs to report.

Similarly, the first information in the PSI may be an identifier, a bit, a field, or the like.

In this implementation, an indication may be implemented in the PSI. Specifically, when a policy is sent to the terminal, each PSI carries some UE policies. These policies may be indicated as reporting after the URSP rule is enforced.

Optionally, the reporting, by the terminal, an enforcement result of a URSP rule according to the first information includes at least one of the following:
in a case that the terminal receives a URSP rule carrying the first information, after the terminal completes enforcement of the URSP rule carrying the first information, reporting, by the terminal, an enforcement result of the URSP rule; or
in a case that the terminal receives a PSI carrying the first information and one or more URSP rules are saved in or associated with the PSI, after the terminal completes enforcement of the URSP rule saved in or associated with the PSI, reporting, by the terminal, an enforcement result of the URSP rule.

In this implementation, a UE policy (for example, the URSP rule) sent by the network to the terminal is sent to the terminal by placing in a policy section (policy section). Each PSI is actually associated with each policy or each type of policy sent to the terminal. After the PSI is associated with the first information (for example, after the PSI is associated with a reporting indication), and after the terminal uses the URSP rule associated with the PSI, the terminal needs to report the enforcement result of the URSP rule. The PSI may carry or associate one or more URSP rules sent to the terminal.

After the terminal completes enforcement of the URSP rule carrying the first information, that the terminal reports the enforcement result of the URSP rule may be: each time after enforcing one URSP rule carrying the first information, the terminal reports an enforcement result of the URSP rule.

After the terminal completes enforcement of the URSP rule saved in or associated with the PSI, that the terminal reports the enforcement result of the URSP rule may be: each time after enforcing one URSP rule saved in or associated with the PSI, the terminal reports an enforcement result of the URSP rule.

In an implementation, one or more URSP rules carry the first information.

Alternatively, one or more PSI carry or associate with the first information.

In this implementation, transmission overheads of the terminal may be reduced by using the foregoing reporting manner.

In an optional implementation, the reporting manner includes at least one of the following:
a first reporting manner, where the first reporting manner is as follows: after the terminal enforces a URSP rule for N times, the terminal reports, by using one piece of second information, enforcement results of the URSP rule enforced for N times, where N is an integer greater than 1;
a second reporting manner, where the second reporting manner is as follows: the terminal reports, by using one piece of second information, enforcement results of all URSP rules enforced by the terminal in one reporting period; or
a third reporting manner, where the third reporting manner is: reporting an enforcement result of a URSP rule by using a non-access stratum NAS message, where each NAS message includes enforcement results of a URSP rule enforced by the terminal for a plurality of times.

The first reporting manner may be as follows: The terminal can report enforcement results of the URSP rule only after the enforcement results are accumulated to a quantity N. For example, after the terminal enforces the URSP rule for 100 or 200 times in total, 100 or 200 enforcement results of the URSP rule are accumulated. In this case, the terminal reports the enforcement results, instead of repeatedly reporting the enforcement results for a plurality of times each time after the terminal enforces the URSP rule once. In this case, 100 or 200 uplink NAS messages are generated. For example, reporting of the non-access stratum (Non-access stratum, NAS) message is triggered only after the URSP rule is enforced by the terminal for N times. Otherwise, the enforcement results are not to be reported. This manner is also accumulative count reporting, where one NAS message is used for reporting only after the count reaches a threshold N.

In addition, the terminal saves an enforcement result of a URSP rule each time, and a time for enforcing the rule, for example, saving as a URSP rule to be enforced for which APP or APP procedure; and enforces a session (session ID) created after the URSP rule is enforced or an existing session (session ID). The terminal needs to save the enforcement result of the URSP rule each time, and then report them in a centralized manner after a requirement is met.

In some implementations, the first information indicates the first reporting manner by carrying N, or N may be defined in a protocol. N may represent a total quantity of times of enforcing the URSP rule or a threshold of a quantity of times of enforcing the URSP rule. When a quantity of times of enforcing the URSP rule by the terminal exceeds this threshold, the terminal reports an enforcement result. Otherwise, the terminal always caches enforcement results of all URSP rules enforced by the terminal.

In some implementations, that after the terminal enforces a URSP rule for N times, the terminal reports, by using one piece of second information, enforcement results of the URSP rule enforced for N times includes:
in a case that the terminal enforces a first URSP rule for N times, the terminal reports, by using one piece of second information, enforcement results of the first URSP rule enforced for N times, where the first URSP rule is corresponding to only one URSP rule in the terminal; or
in a case that the terminal enforces a URSP rule for N times, the terminal reports, by using one piece of second information, enforcement results of the URSP rule enforced by the terminal for N times, where enforcement of the URSP rule for N times is not limited to enforcement of a same URSP rule.

The first URSP rule indicates that the N times are for one URSP rule, that is, reporting is performed only after a URSP rule is enforced for N times.

In addition, in the foregoing implementation, the URSP rule is not limited in the N times, that is, a quantity of times of all URSP rules enforced by the terminal reaches N times. For example, the terminal reports an enforcement result only after a plurality of URSP rules are enforced for N times.

The second information includes at least one of the following (a second information form between the UE and the AMF or the SMF):
a registration accept (Registration accept) message;
a downlink NAS message (DL NAS message) message;
a PDU session establishment accept (PDU session establishment accept) message; or
a PDU session modification accept (PDU session modification accept) message.

The second information is finally sent to the PCF (including the AM-PCF and the UE-PCF). The second information is first sent to the AMF or the SMF, and then the AMF or the SMF further uses at least one of the following to send the enforcement result of the URSP rule to the PCF (including the AM-PCF and the UE-PCF). Therefore, the second information may further be (a second information form between the AMF or the SMF and the PCF). The AMF may send the second information to the PCF by using at least one of the following:

The AMF directly sends the second information to the PCF (the AM-PCF or the UE-PCF) by using at least one of the following:
a UE policy control create or update request (Npcf_UEPolicyControl Create/Update request) message.

The AMF may further first send the second information to the SMF, then the SMF sends the second information to an SM-PCF, and then the SM-PCF sends the second information to the PCF (the AM-PCF or the UE-PCF). The method is as follows:

The AMF sends the second information to the SMF: a PDU session create/update session management context request (Nsmf_PDUSession_CreateSMContext Request or Nsmf_PDUSession_UpdateSMContext Request) message.

The SMF then sends the second information to the SM-PCF: a session management policy control create or update request (Npcf_SMPolicyControl Create/Update request) message.

The SM-PCF then sends the second information to the PCF (the AM-PCF or the UE-PCF): a UE policy control create or update request (Npcf_UEPolicyControl Create/Update request) message.

In some implementations, the second information is carried in an uplink NAS message or the second information is an uplink NAS message.

The second reporting manner may be as follows: The terminal performs offline collection, and does not need to perform reporting each time after the terminal enforces the URSP rule. The terminal caches the URSP rule used each time. Then, reporting may be performed with the reporting period.

The reporting period may be a time period such as one week or one month.

In some implementations, the terminal may alternatively perform reporting only when a network indication is received. For example, the terminal always caches an enforcement result of the URSP rule enforced by the terminal each time, but does not report the enforcement result to the network. Only after the terminal receives one piece of indication information (for example, by using a downlink NAS message) sent by the network-side device, the terminal reports the enforcement result of the URSP rule. For example, the terminal may alternatively cache enforcement results of URSP rules within at least a few days according to a network side requirement, for example, at least one week, and report the enforcement results only when a network indication is received.

In some implementations, the first information indicates the second reporting manner by carrying indication information of the reporting period. Alternatively, the reporting period may be defined in a protocol.

The third reporting manner may be as follows: One NAS message is specially used to report enforcement results of all URSP rules enforced by the terminal. In this way, uploading is avoided in each PDU session establishment (PDU session establishment) message, so as to avoid performing uploading once by using each session for a plurality of times, thereby reducing transmission overheads.

The NAS message is an uplink NAS message (UL NAS message). For example, reporting is performed by using a path of the terminal->the AMF->the access and mobility management (Access and Mobility Management PCF, AM-PCF)/UE PCF (UE-PCF), or reporting is performed by using a path of the terminal->the AMF->the SMF->the session management PCF (Session Management PCF, SM-PCF)->the UE-PCF, or reporting is performed by using a path of a UE APP->a mobile network operator (mobile network operator, MNO) application function (application function, AF)->the UE-PCF.

Optionally, the reporting, by the terminal, an enforcement result of a URSP rule according to the first information includes at least one of the following:
in a case that the reporting manner includes the first reporting manner, saving, by the terminal, an enforcement result of an enforced URSP rule, and when a quantity of times of enforcing the URSP rule by the terminal reaches N or more, reporting the saved enforcement result by using one piece of second information;
in a case that the reporting manner includes the second reporting manner, saving, by the terminal, an enforcement result of an enforced URSP rule within a time indicated by a reporting period, and when an end time of the reporting period is reached, reporting the saved enforcement result by using one piece of second information; or
in a case that the reporting manner includes the third reporting manner, reporting, by the terminal, an enforcement result of a URSP rule by using the NAS message, where the NAS message includes enforcement results of a URSP rule enforced by the terminal for a plurality of times or includes enforcement results of a plurality of URSP rules enforced by the terminal.

When the quantity of times of enforcing the URSP rule by the terminal reaches N or more, reporting the saved enforcement result by using one piece of second information may be: when a quantity of times of accumulatively enforcing the URSP rule by the terminal reaches N or more, reporting the saved enforcement result by using one piece of second information.

The terminal saves the enforcement result of the URSP rule enforced within the time indicated by the reporting period. When the end time of the reporting period is reached, reporting the saved enforcement result by using one piece of second information may be as follows: The terminal saves the enforcement result of the URSP rule enforced within the time indicated by the reporting period, and when the reporting period ends, reports the saved enforcement result by using one piece of second information.

That the terminal reports the enforcement result of the URSP rule by using the NAS message may be that the terminal reports, by using the NAS message, enforcement results of the URSP rule enforced by the terminal for a plurality of times.

In some implementations, when the first information includes the reporting content and the reporting manner, the terminal may report, in the reporting manner, an enforcement result of a specific URSP rule corresponding to the reporting content.

In an optional implementation, the enforcement result of the URSP rule includes: an identifier of the URSP rule;
enforcement frequency of the URSP rule; APP information, where the APP information is used to indicate the terminal to enforce a URSP rule for an APP or APP traffic corresponding to the APP information, or the APP information is used to indicate an APP or APP traffic on the terminal corresponding to the enforcement result of the URSP rule reported by the terminal;
a traffic descriptor;
an RSD;
a traffic descriptor precedence; and
an RSD precedence.

The enforcement frequency of the URSP rule may be enforcement frequency of one or more URSP rules, or total enforcement frequency of the specific URSP rule corresponding to the reporting content enforced by the terminal.

For example, after the terminal enforces a URSP rule for an application or application traffic, an enforcement result of the URSP rule is a rule specifically used for this application, for example, which traffic descriptor is used, and which RSD is used. The URSP rule identifier, the RSD, the traffic descriptor, the RSD precedence, the traffic descriptor precedence, and the like are all used to indicate a rule that the terminal actually uses for the APP or the APP traffic.

In some implementations, reporting the enforcement result of the URSP rule may be reporting an original text of the URSP rule, for example:

Content shown in Table 4 is reported:

TABLE 4

| | |
|---|---|
| Rule Precedence = 1 | Route Selection Descriptor Precedence = 1 |
| Traffic Descriptor: | (RSC) Network Slice Selection: S-NSSAI-a |
| Application descriptor = | SSC Mode Selection: SSC Mode 3 |
| App1 | DNN Selection: internet |
| | Access Type preference: 3GPP access |

In some implementations, the enforcement result of the URSP rule may be identification information of the URSP rule. For example, in Table 4, an SSC mode (SSC mode) is represented by 1, or in an SSC mode+PDU session type (PDU session type), renumbering is performed to form a character. For example, the first bit of 00 represents an SSC mode, the second bit represents a DNN, 0 represents SSC mode 1, 1 represents SSC mode 2, for example, 00 represents SSC mode 1+DNN1, and 10 represents SSC mode 2+DNN1. In this way, a long string of original fields is avoided, and a quantity of data sent by the network is reduced. An advantage of this design is that instead of reporting an original text of an enforcement result of a URSP rule each time, one character string is directly read. By identifying 0 or 1, an enforcement result of a specific URSP rule can be learned. Sending the original text of the enforcement result consumes a relatively large NAS resource and a relatively large capacity and wastes resources. Sending the character string is more economical. Only a format for reporting needs to be agreed on with the network side.

In embodiments of this application, a terminal receives first information sent by a network-side device, and the terminal reports an enforcement result of a UE route selection policy URSP rule according to the first information; where the first information is used to indicate at least one of the following: reporting content or a reporting manner; where in a case that the first information indicates the reporting content, the terminal reports an enforcement result of one or more specific URSP rules each time, and/or the terminal reports each time an enforcement result of enforcing a URSP rule for a specific application APP or APP traffic; or in a case that the first information indicates the reporting manner, the terminal reports each time enforcement results of a URSP rule enforced by the terminal for a plurality of times. In this way, the terminal may report, according to the first information, only an enforcement result of a specific URSP rule and/or of enforcing a URSP rule for a specific application APP or APP traffic, or report, at a time, enforcement results of a URSP rule enforced by the terminal for a plurality of times, thereby reducing transmission overheads of the terminal.

In a case that the traffic descriptor in the URSP rule received by the terminal from the network side includes a plurality of traffic descriptor components (Traffic descriptor components), after the terminal enforces or uses the URSP rule for an application, an enforcement status or a use status of the URSP rule involves enforcement statuses or use statuses of the plurality of traffic descriptor components, and an enforcement result of the URSP rule sent to the network side may involve information about a plurality of traffic descriptors used or enforced by the terminal (for example, a plurality of traffic descriptors, a plurality of traffic descriptor components, and values of a plurality of traffic descriptor components). How to report the enforcement result or a usage result of the URSP rule is a technical problem that needs to be resolved. To resolve the foregoing problem, an embodiment further provides an enforcement result reporting method, where the enforcement result reporting method includes:

A terminal enforces a second URSP rule, and the terminal reports an enforcement result of the second URSP rule according to a first reporting rule, where the second URSP rule includes a plurality of traffic descriptor components, and the plurality of traffic descriptor components include a first traffic descriptor component and a second traffic descriptor component; and the first reporting rule includes at least one of the following:
reporting an enforcement result of the first traffic descriptor component, and not reporting an enforcement result of the second traffic descriptor component;
reporting enforcement results of all traffic descriptor components (that is, the plurality of traffic descriptor components) in the second URSP rule;
not reporting enforcement results of all traffic descriptor components in the second URSP rule;
reporting a rule precedence (rule precedence) of the second URSP rule;
not reporting a rule precedence of the second URSP rule;
reporting a rule precedence of the second URSP rule including the second traffic descriptor component; or not reporting a rule precedence of the second URSP rule including the second traffic descriptor component.

In this embodiment of this application, in a case that the enforced URSP rule includes a plurality of traffic descriptor components, the enforcement result of the URSP rule may be differently reported.

In an implementation, the first traffic descriptor component includes a traffic descriptor component that does not involve privacy, and the second traffic descriptor component includes a traffic descriptor component that involves privacy. A privacy exposure problem can be resolved by reporting an enforcement result of a traffic descriptor component that does not involve privacy, not reporting an enforcement result of a traffic descriptor component that involves privacy, or not reporting enforcement results of all traffic descriptor components.

In another implementation, the first traffic descriptor component includes a connection capability, and the second traffic descriptor component includes any one or more other traffic descriptor components. It may be understood that “any one or more other traffic descriptor components” are a traffic descriptor component different from a connection capability.

In another implementation, the first traffic descriptor component includes a connection capability, and the second traffic descriptor component includes an application descriptor.

In another implementation, the first traffic descriptor component includes any one or more other traffic descriptor components than an application descriptor, and the second traffic descriptor component includes an application descriptor. A method for defining the first traffic descriptor component and the second traffic descriptor component is not limited to the cases enumerated in the foregoing embodiments.

In the first reporting rule, alternatively, reporting methods for different traffic descriptor components may not be distinguished according to whether privacy is exposed. In the first reporting rule, different traffic descriptor components may be divided into several categories, and then each category uses a different reporting manner. For example, in the second URSP rule, a reporting manner is set for a traffic descriptor component with a connection capability. In the second URSP rule, another reporting manner is set for a traffic descriptor component other than the traffic descriptor component with a connection capability. In this case, whether privacy is involved is not distinguished. However, in this case, different reporting manners may be specified in the first reporting rule for use situations of different URSP rules, or for use situations including different traffic descriptors or traffic descriptor components, and reporting of different use results may be specified, so as to implement differentiation.

Optionally, in a case that the first reporting rule is that the terminal reports enforcement results of all traffic descriptor components in the second URSP rule, the reported enforcement result of the second traffic descriptor component is represented by a fixed value. Optionally, one traffic descriptor component is corresponding to one fixed value. Certainly, a plurality of traffic descriptor components may be corresponding to one fixed value. Optionally, the fixed value is determined through negotiation with the network or is agreed upon in a protocol. This method can also solve the problem of privacy exposure.

As an example, the plurality of traffic descriptor components include a connection capability and any one or more other traffic descriptor components, where the any one or more other traffic descriptor components include one or more of an application descriptor (Application descriptor), an IP descriptor (IP descriptor), a domain descriptor (Domain descriptor), a non-IP descriptor (Non-IP descriptor), and a data network name (DNN), and the first reporting rule includes at least one of the following:
reporting an enforcement result of the connection capability, and not reporting an enforcement result of the any one or more other traffic descriptor components;
not reporting an enforcement result of the connection capability, and not reporting an enforcement result of the any one or more other traffic descriptor components;
reporting an enforcement result of the connection capability and an enforcement result of the any one or more other traffic descriptor components;
reporting an enforcement result of the connection capability and an enforcement result of the any one or more other traffic descriptor components, where the enforcement result of the any one or more other traffic descriptor components is a fixed value;
reporting a rule precedence of the second URSP rule;
not reporting a rule precedence of the second URSP rule;
reporting a rule precedence of a second URSP rule including a connection capability traffic descriptor component (enforcing the component or the second URSP rule);
reporting a rule precedence of a second URSP rule including a connection capability traffic descriptor component and any one or more other traffic descriptor components (enforcing the traffic descriptor, or enforcing the traffic descriptor component, or the second URSP rule);
not reporting a rule precedence of a second URSP rule including a connection capability traffic descriptor component (enforcing the component or the second URSP rule);
not reporting a rule precedence of a second URSP rule including a connection capability traffic descriptor component and any one or more other traffic descriptor components (enforcing the traffic descriptor, or enforcing the traffic descriptor component, or the second URSP rule); or
not reporting a rule precedence of a second URSP rule including any one or more other traffic descriptor components.

In another example, the plurality of traffic descriptor components include a connection capability (Connection Capabilities or Connection Capability) and an application descriptor (Application descriptor), and the first reporting rule includes at least one of the following:
reporting an enforcement result of the connection capability and not reporting an enforcement result of the application descriptor;
not reporting an enforcement result of the connection capability and not reporting an enforcement result of the application descriptor;
reporting an enforcement result of the connection capability and an enforcement result of the application descriptor;
reporting an enforcement result of the connection capability and an enforcement result of the application descriptor, where the enforcement result of the application descriptor is a fixed value;
reporting a rule precedence of the second URSP rule;
not reporting a rule precedence of the second URSP rule;
reporting a rule precedence rule precedence of a second URSP rule including a connection capability traffic descriptor component (enforcing the component or the second URSP rule);
reporting a rule precedence of a second URSP rule including a connection capability traffic descriptor component and an application descriptor traffic descriptor component (enforcing the traffic descriptor, or enforcing the traffic descriptor component, or the second URSP rule);
not reporting a rule precedence of a second URSP rule including a connection capability traffic descriptor component (enforcing the component or the second URSP rule); or
not reporting a rule precedence of a second URSP rule including a connection capability traffic descriptor component and an application descriptor traffic descriptor component (enforcing the traffic descriptor, or enforcing the traffic descriptor component, or the second URSP rule).

In an implementation, the terminal receives the second reporting rule indicated by the network-side device, and the terminal reports the enforcement result of the second URSP rule according to the first reporting rule. The first reporting rule is different from the second reporting rule. The second reporting rule includes at least one of the following: reporting an enforcement result of the first traffic descriptor component, and not reporting an enforcement result of the second traffic descriptor component; reporting enforcement results of all traffic descriptor components (that is, the plurality of traffic descriptor components) in the second URSP rule; not reporting enforcement results of all traffic descriptor components in the second URSP rule; reporting a rule precedence of the second URSP rule; reporting a rule precedence of a second URSP rule including the second traffic descriptor component; or not reporting a rule precedence of a second URSP rule including the second traffic descriptor component. For example, the second reporting rule indicated by the network-side device and received by the terminal is reporting the enforcement results of all the traffic descriptor components in the second URSP rule, but the terminal reports the enforcement result of the first traffic descriptor component, but does not report the enforcement result of the second traffic descriptor component.

In an implementation, the terminal receives the first reporting rule indicated by the network-side device, and the terminal reports the enforcement result of the second URSP rule according to the first reporting rule. It may be understood that the terminal reports the enforcement result according to an indication of the network side. For example, if the first reporting rule indicated by the network-side device and received by the terminal is reporting the enforcement result of the first traffic descriptor component and not reporting the enforcement result of the second traffic descriptor component, the terminal reports the enforcement result of the first traffic descriptor component and does not report the enforcement result of the second traffic descriptor component.

It should be noted that the enforcement result of the second URSP rule is similar to the enforcement result of the URSP rule in the foregoing description. For the enforcement result of the second URSP rule, references may be made to the foregoing description of the enforcement result of the URSP rule.

In an implementation, the enforcement result of the second URSP rule includes:
an identifier of the second URSP rule;
enforcement frequency of the second URSP rule;
APP information, where the APP information is used to indicate the terminal to enforce the second URSP rule for an APP or APP traffic corresponding to the APP information, or the APP information is used to indicate an APP or APP traffic on the terminal corresponding to the enforcement result of the second URSP rule reported by the terminal;
a traffic descriptor;
a route selection descriptor RSD;
a traffic descriptor precedence; and
an RSD precedence.

It may be understood that, after the terminal enforces the second URSP rule for an application or application traffic, an enforcement result of the second URSP rule is a rule specifically used for this application, for example, which traffic descriptor in the second URSP rule is used, and which RSD in the second URSP rule is used. The URSP rule identifier, the RSD, the traffic descriptor, the RSD precedence, the traffic descriptor precedence, and the like are all used to indicate a rule that the terminal actually uses for the APP or the APP traffic.

Optionally, the enforcement result of the second URSP rule includes information about a traffic descriptor, such as a traffic descriptor, a traffic descriptor component, or a value of a traffic descriptor component.

In an implementation, the terminal receives, by using at least one of the following signaling or message, the first reporting rule or the second reporting rule indicated by the network-side device:
registration accept (Registration accept);
a downlink NAS message;
a UE policy container (UE policy container);
PDU session establishment accept (PDU session establishment accept); or
PDU session modification accept (PDU session modification accept).

In an implementation, the first reporting rule is agreed upon in a protocol. Alternatively, the terminal autonomously determines the first reporting rule without an indication of the network-side device.

In an implementation, the enforcement result of the second URSP rule, or the enforcement result of the first URSP rule, or the enforcement result of the traffic descriptor in the second URSP rule, or the traffic descriptor component in the second URSP rule may be sent to the network-side device by using at least one of the following signaling. The network-side device may be any core network device such as an AMF, an SMF, or a PCF, which is not specifically limited: an uplink NAS message;
a PDU session modification request (PDU session modification request);
a registration request (registration request); or
a PDU session establishment request (PDU session establishment request).

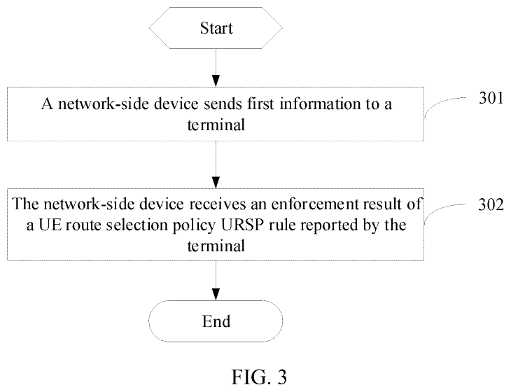

Referring to FIG. 3, FIG. 3 is a flowchart of an enforcement result receiving method according to an embodiment of this application. As shown in FIG. 3, the method includes the following steps:

Step 301: A network-side device sends first information to a terminal.

Step 302: The network-side device receives an enforcement result of a UE route selection policy URSP rule reported by the terminal;
where the first information is used to indicate at least one of the following:
reporting content and a reporting manner;
where in a case that the first information indicates the reporting content, the terminal reports an enforcement result of one or more specific URSP rules each time, and/or the terminal reports each time an enforcement result of enforcing a URSP rule for a specific application APP or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

Optionally, the enforcement result of the URSP rule refers to a URSP rule enforced or used by the terminal for at least one APP or traffic of at least one APP.

Optionally, the reporting content includes at least one of the following:
a first URSP rule set, where the first URSP rule set includes at least one URSP rule;
a first APP set, where the first APP set includes at least one APP;
at least one time period; or
at least one terminal location.

Optionally, the first information indicates the at least one URSP rule in the first URSP rule set by carrying at least one of the following:
a URSP rule identifier, a traffic descriptor, a traffic descriptor precedence, a route selection descriptor, or a route selection descriptor precedence.

Optionally, the first information indicates the at least one APP in the first APP set by carrying at least one of the following:
an APP identifier, an application operating system identifier APP OSID, a source address or a source port number of an APP, a destination address or a destination port number accessed by an APP, a fully qualified domain name FQDN used or requested by an APP, or a data network name DNN used or requested by an APP.

M Optionally, the first information indicates the at least one time period by carrying time information; and/or
the first information indicates the at least one terminal location by carrying at least one of the following:
UE location information or area of interest AOI information.

Optionally, the first information is carried in at least one of the following:
at least one URSP rule; or
a policy section identifier PSI corresponding to at least one URSP rule.

Optionally, the reporting manner includes at least one of the following:
a first reporting manner, where the first reporting manner is as follows: after the terminal enforces a URSP rule for N times, the terminal reports, by using one piece of second information, enforcement results of the URSP rule enforced for N times, where N is an integer greater than 1;
a second reporting manner, where the second reporting manner is as follows: the terminal reports, by using one piece of second information, enforcement results of all URSP rules enforced by the terminal in one reporting period; or
a third reporting manner, where the third reporting manner is: reporting an enforcement result of a URSP rule by using a non-access stratum NAS message, where each NAS message includes enforcement results of a URSP rule enforced by the terminal for a plurality of times.

Optionally, the first information indicates the first reporting manner by carrying N, and N is used to indicate a quantity of times of accumulating URSP rules; or
the first information indicates the second reporting manner by carrying indication information of the reporting period.

Optionally, that after the terminal enforces a URSP rule for N times, the terminal reports, by using one piece of second information, enforcement results of the URSP rule enforced for N times includes:
in a case that the terminal enforces a first URSP rule for N times, the terminal reports, by using one piece of second information, enforcement results of the first URSP rule enforced for N times, where the first URSP rule is corresponding to only one URSP rule in the terminal; or
in a case that the terminal enforces a URSP rule for N times, the terminal reports, by using one piece of second information, enforcement results of the URSP rule enforced by the terminal for N times, where enforcement of the URSP rule for N times is not limited to enforcement of a same URSP rule.

Optionally, the second information is carried in an uplink NAS message or the second information is an uplink NAS message.

Optionally, the enforcement result of the URSP rule includes:
an identifier of the URSP rule;
enforcement frequency of the URSP rule; APP information, where the APP information is used to indicate the terminal to enforce a URSP rule for an APP or APP traffic corresponding to the APP information, or the APP information is used to indicate an APP or APP traffic on the terminal corresponding to the enforcement result of the URSP rule reported by the terminal;
a traffic descriptor;
a route selection descriptor RSD;
a traffic descriptor precedence; and
an RSD precedence.

It should be noted that this embodiment is used as an implementation of the network-side device corresponding to the embodiment shown in FIG. 2. For a specific implementation thereof, references may be made to related descriptions of the embodiment shown in FIG. 2. To avoid repetition, details are not described in this embodiment.

The following uses a plurality of embodiments to illustrate the method provided in embodiments of this application.

### Embodiment 1

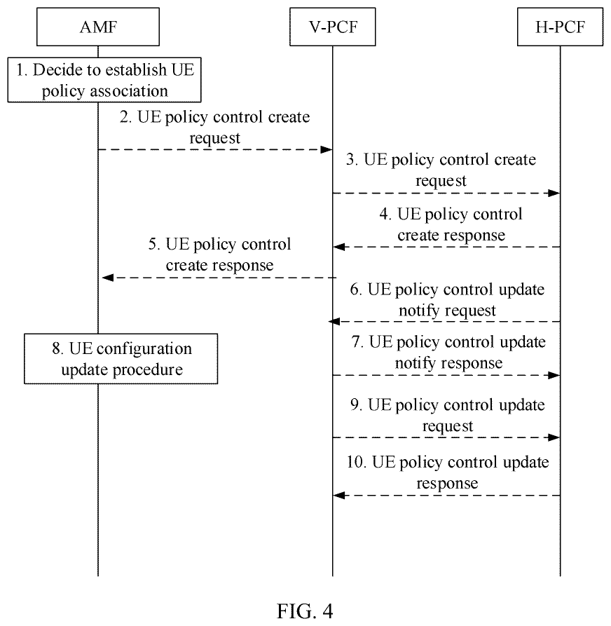

This embodiment is described by using an example in which first information is delivered in a process of establishing UE policy association. As shown in FIG. 4, the following steps are included:

Step 1: An AMF decides to establish UE policy association.

Step 2: The AMF sends a UE policy control create request (Npcf_UE PolicyControl_Create Request) to a visited PCF (visited PCF, V-PCF).

In step 2, the AMF sends a UE policy control create request to the PCF, where the PCF may be an AM-PCF or a UE-PCF.

Step 3: The V-PCF sends the UE policy control create request (Npcf_UE PolicyControl_Create Request) to a home PCF (home PCF, H-PCF).

Step 4: The H-PCF sends a UE policy control create response (Npcf_UE PolicyControl_Create Response) to the V-PCF.

Step 5: The V-PCF sends the UE policy control create response (Npcf_UE PolicyControl_Create Response) to the AMF.

The response includes the first information.

Step 6: The H-PCF sends a UE policy control update notify request (Npcf_UE PolicyControl_UpdateNotify Request) to the V-PCF.

Step 7: The V-PCF sends a UE policy control update notify response (Npcf_UE PolicyControl_UpdateNotify Response) to the H-PCF.

Step 8: UE configuration update procedure (UE configuration Update procedure).

Step 9: The V-PCF sends a UE policy control update request (Npcf_UE PolicyControl_UpdateRequest) to the H-PCF.

Step 10: The V-PCF sends a UE policy control update response (Npcf_UE PolicyControl_UpdateResponse) to the H-PCF.

### Embodiment 2

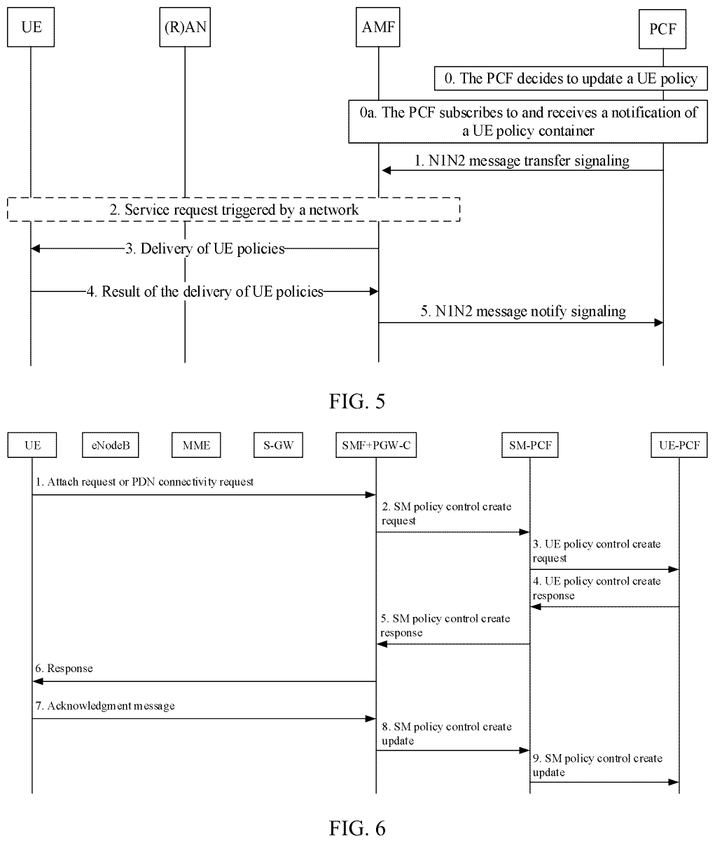

This embodiment is described by using an example in which first information is delivered in a UE configuration update (UE Configuration Update, UCU) procedure. As shown in FIG. 5, the following steps are included:

Step 0: A PCF decides to update a UE policy.

Step 0a: The PCF subscribes to and receives a notification of a UE policy container.

Step 1: The PCF sends N1N2 message transfer signaling (Namf_Communication_NIN2MessageTransfer) to an AMF, where the message carries the first information.

Step 2: A service request triggered by a network.

Step 3: The AMF provides a UE with a UE policy (Delivery of UE policies). In this step, the AMF further sends the first information to the UE. In this step, the AMF may send the first information to the UE by using a downlink NAS message. In addition, in this step, the first information and a URSP rule may be further sent to the UE. In addition, the sent URSP rule may also carry the first information, for example, the first information is carried in each URSP rule, and carries a reporting indication.

Step 4: The UE sends a result of the delivery of UE policies (Result of the delivery of UE policies) to the AMF.

Step 5: The AMF sends N1N2 message notify signaling (Namf_Communication_N1MessageNotify) to the PCF.

### Embodiment 3

This embodiment is described by using an example in which an AMF or an SMF sends first information to a UE by using a downlink NAS message (DL NAS message). The NAS message may be a newly defined NAS message. As shown in FIG. 6, the following steps are included:

Step 1: The UE sends an attach request or a PDN connectivity request (Attach Request or PDN Connectivity Request) to the SMF+a gateway control plane (PDN Packet Data Networks GatewayControl PGW-C).

Step 2: The SMF+PGW-C sends an SM policy control create request (Npcf_SMPolicyControl_Create Request) to an SM-PCF.

Step 3: The SM-PCF sends a UE policy control create request (Npcf_UEPolicyControl Create Request) to a UE-PCF.

Step 4: The UE-PCF sends a UE policy control create response (Npcf_UEPolicyControl_Create Response) to the SM-PCF. In this step, the UE-PCF generates first information and sends the first information to the SM-PCF.

Step 5: The SM-PCF sends an SM policy control create response (Npcf_SMPolicyControl_Create Response) to the SMF+PGW-C. In this step, the first information is sent to the SMF+PGW-C.

Step 6: The SMF+PGW-C sends a response to the UE. In this step, the SMF+PGW-C sends the first information to the UE.

Step 7: The UE sends an acknowledgment message (Acknowledgement) to the SMF+PGW-C.

Step 8: The SMF+PGW-C sends an SM policy control create update (Npcf_SMPolicyControl_Create Update) to the SM-PCF.

Step 9: The SM-PCF sends the SM policy control create update (Npcf_SMPolicyControl_Create Update) to the UE-PCF.

### Embodiment 4

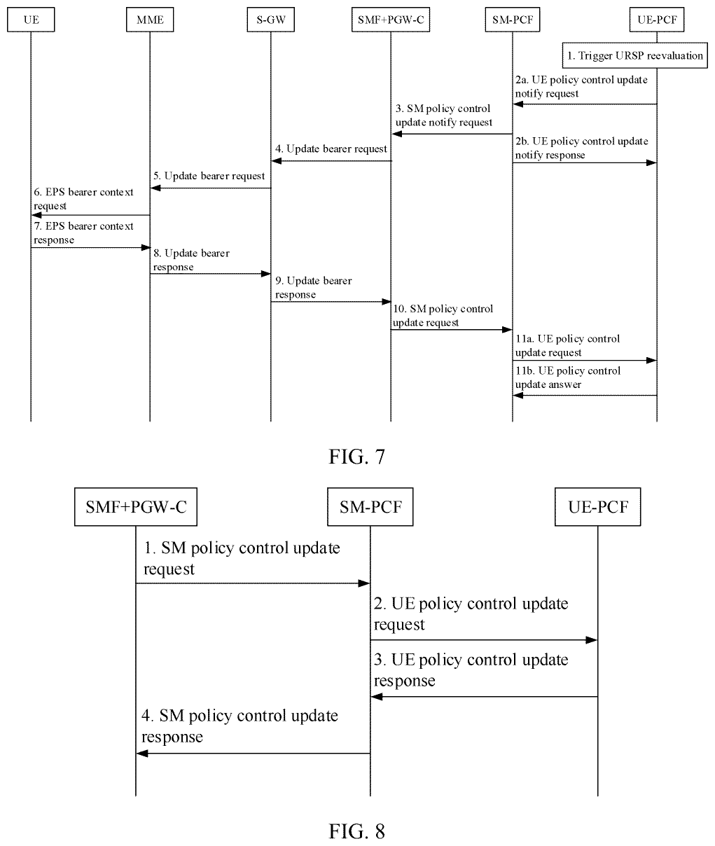

As shown in FIG. 7, this embodiment includes the following steps:

Step 1: A UE-PCF triggers URSP reevaluation.

Step 2a: The UE-PCF sends a UE policy control update notify request (Npcf_UEPolicyControl_UpdateNotify request) to an SM-PCF. In this step, the UE-PCF sends first information to the SM-PCF.

Step 2b: The SM-PCF sends a UE policy control update notify response (Npcf_UEPolicyControl_UpdateNotify response) to the UE-PCF.

Step 3: The SM-PCF sends an SM policy control update notify request (Npcf_SMPolicyControl_UpdateNotify request) to an SMF+PGW-C.

Step 4: The SM-PCF sends an update bearer request (Update Bearer Request) to an S-GW.

Step 5: The S-GW sends an update bearer request (Update Bearer Request) to an MME.

Step 6: The MME sends an EPS bearer context request (EPS Bearer Context Request) to a UE.

The first information is gradually sent to the UE side by performing step 3, step 4, step 5, and step 6. In addition, indication information may be sent by using an additional message, or a same message may be extended to send the indication information along with a URSP rule in a Protocol Configuration Option (PCO).

Step 7: The UE sends an EPS bearer context response (EPS Bearer Context Response) to the MME.

Step 8: The MME sends an update bearer response (Update Bearer Response) to the S-GW.

Step 9: The S-GW sends the update bearer response (Update Bearer Response) to the SMF+PGW-C.

Step 10: The SMF+PGW-C sends an SM policy control update request (Npcf_SMPolicyControl Update request) to the SM-PCF.

Step 11a: The SM-PCF sends a UE policy control update request (Npcf_UEPolicyControl_Update request) to the UE-PCF.

Step 11b: The UE-PCF sends a UE policy control update answer (Npcf_UEPolicyControl_Update ans) to the SM-PCF.

### Embodiment 5

As shown in FIG. 8, this embodiment includes the following steps:

Step 1: An SMF+PGW-C sends an SM policy control update request (Npcf_SMPolicyControl Update Request) to an SM-PCF.

Step 2: The SM-PCF sends a UE policy control update request (Npcf_UEPolicyControl_Update Request) to a UE-PCF.

Step 3: The UE-PCF sends a UE policy control update response (Npcf_UEPolicyControl_Update Response) to the SM-PCF.

Step 4: The SM-PCF sends an SM policy control update response (Npcf_SMPolicyControl Update Response) to the SMF+PGW-C.

In this embodiment, by performing step 3 and step 4, first information is sent to the SM-PCF, and the SM-PCF sends the first information to the UE, for example, sends the first information to the UE by using a downlink NAS message.

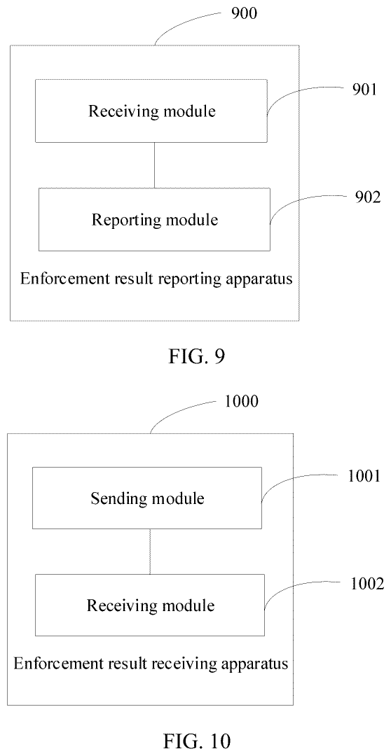

Referring to FIG. 9, FIG. 9 is a structural diagram of an enforcement result reporting apparatus according to an embodiment of this application. As shown in FIG. 9, the enforcement result reporting apparatus 900 includes:
a receiving module 901, configured to receive first information sent by a network-side device; and
a reporting module 902, configured to report an enforcement result of a UE route selection policy URSP rule according to the first information;
where the first information is used to indicate at least one of the following:
reporting content or a reporting manner;
where in a case that the first information indicates the reporting content, the terminal reports an enforcement result of one or more specific URSP rules each time, and/or the terminal reports each time an enforcement result of enforcing a URSP rule for a specific application APP or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

Optionally, the enforcement result of the URSP rule refers to a URSP rule enforced or used by the terminal for at least one APP or traffic of at least one APP.

Optionally, the reporting content includes at least one of the following:
a first URSP rule set, where the first URSP rule set includes at least one URSP rule;
a first APP set, where the first APP set includes at least one APP;
at least one time period; or
at least one terminal location.

Optionally, the reporting module 902 is configured to perform at least one of the following:
in a case that the reporting content includes the first URSP rule set, after the terminal enforces a URSP rule in the first URSP rule set, reporting an enforcement result of the URSP rule;
in a case that the reporting content includes the first APP set, after the terminal enforces a URSP rule for an APP or APP traffic that belongs to the first APP set, reporting an enforcement result of the URSP rule;
in a case that the reporting content includes the at least one time period, after the terminal enforces a URSP rule within a time indicated by the at least one time period, reporting an enforcement result of the URSP rule; or
in a case that the reporting content includes the at least one terminal location, after the terminal enforces a URSP rule at a terminal location in the at least one terminal location, reporting an enforcement result of the URSP rule.

Optionally, the first information indicates the at least one URSP rule in the first URSP rule set by carrying at least one of the following:
a URSP rule identifier, a traffic descriptor, a traffic descriptor precedence, a route selection descriptor, or a route selection descriptor precedence.

Optionally, the first information indicates the at least one APP in the first APP set by carrying at least one of the following:
an APP identifier, an application operating system identifier APP OSID, a source address or a source port number of an APP, a destination address or a destination port number accessed by an APP, a fully qualified domain name FQDN used or requested by an APP, or a data network name DNN used or requested by an APP.

Optionally, the first information indicates the at least one time period by carrying time information; and/or
the first information indicates the at least one terminal location by carrying at least one of the following:
UE location information and area of interest AOI information.

Optionally, the first information is carried in at least one of the following:
at least one URSP rule; or
a policy section identifier PSI corresponding to at least one URSP rule.

Optionally, the reporting module 902 is configured to perform at least one of the following:
in a case that the terminal receives a URSP rule carrying the first information, after the terminal completes enforcement of the URSP rule carrying the first information, reporting an enforcement result of the URSP rule; or
in a case that the terminal receives a PSI carrying the first information and one or more URSP rules are saved in or associated with the PSI, after the terminal completes enforcement of the URSP rule saved in or associated with the PSI, reporting an enforcement result of the URSP rule.

Optionally, the reporting manner includes at least one of the following:
a first reporting manner, where the first reporting manner is as follows: after the terminal enforces a URSP rule for N times, the terminal reports, by using one piece of second information, enforcement results of the URSP rule enforced for N times, where N is an integer greater than 1;
a second reporting manner, where the second reporting manner is as follows: the terminal reports, by using one piece of second information, enforcement results of all URSP rules enforced by the terminal in one reporting period; or
a third reporting manner, where the third reporting manner is: reporting an enforcement result of a URSP rule by using a non-access stratum NAS message, where each NAS message includes enforcement results of a URSP rule enforced by the terminal for a plurality of times.

Optionally, the first information indicates the first reporting manner by carrying N, and N is used to indicate a quantity of times of accumulating URSP rules; or
the first information indicates the second reporting manner by carrying indication information of the reporting period.

Optionally, the reporting module 902 is configured to perform at least one of the following:
in a case that the reporting manner includes the first reporting manner, saving an enforcement result of an enforced URSP rule, and when a quantity of times of enforcing the URSP rule by the terminal reaches N or more, reporting the saved enforcement result by using one piece of second information;
in a case that the reporting manner includes the second reporting manner, saving an enforcement result of an enforced URSP rule within a time indicated by a reporting period, and when an end time of the reporting period is reached, reporting the saved enforcement result by using one piece of second information; or
in a case that the reporting manner includes the third reporting manner, reporting, by the terminal, an enforcement result of a URSP rule by using the NAS message, where the NAS message includes enforcement results of a URSP rule enforced by the terminal for a plurality of times or includes enforcement results of a plurality of URSP rules enforced by the terminal.

Optionally, that after the terminal enforces a URSP rule for N times, the terminal reports, by using one piece of second information, enforcement results of the URSP rule enforced for N times includes:
in a case that the terminal enforces a first URSP rule for N times, the terminal reports, by using one piece of second information, enforcement results of the first URSP rule enforced for N times, where the first URSP rule is corresponding to only one URSP rule in the terminal; or
in a case that the terminal enforces a URSP rule for N times, the terminal reports, by using one piece of second information, enforcement results of the URSP rule enforced by the terminal for N times, where enforcement of the URSP rule for N times is not limited to enforcement of a same URSP rule.

Optionally, the second information is carried in an uplink NAS message or the second information is an uplink NAS message.

Optionally, the enforcement result of the URSP rule includes:
an identifier of the URSP rule;
enforcement frequency of the URSP rule;
APP information, where the APP information is used to indicate the terminal to enforce a URSP rule for an APP or APP traffic corresponding to the APP information, or the APP information is used to indicate an APP or APP traffic on the terminal corresponding to the enforcement result of the URSP rule reported by the terminal;
a traffic descriptor;
a route selection descriptor RSD;
a traffic descriptor precedence; and
an RSD precedence.

The enforcement result reporting apparatus can reduce transmission overheads.

The enforcement result reporting apparatus in this embodiment of this application may be an electronic device, for example, an electronic device with an operating system, or may be a component in the electronic device, for example, an integrated circuit or a chip. For example, the electronic device may be a terminal, or may be another device different from a terminal. For example, the terminal may include but is not limited to the foregoing listed types of the terminal in embodiments of this application. The another device may be a server, a Network Attached Storage (NAS), or the like. This is not specifically limited in the embodiments of this application.

The enforcement result reporting apparatus provided in this embodiment of this application can implement processes implemented in the method embodiment in FIG. 2, and achieve same technical effects. To avoid repetition, details are not described herein again.

Referring to FIG. 10, FIG. 10 is a structural diagram of an enforcement result receiving apparatus according to an embodiment of this application. As shown in FIG. 10, the enforcement result receiving apparatus 1000 includes:
a sending module 1001, configured to send first information to a terminal; and
a receiving module 1002, configured to receive an enforcement result of a UE route selection policy URSP rule reported by the terminal;
where the first information is used to indicate at least one of the following:
reporting content or a reporting manner;
where in a case that the first information indicates the reporting content, the terminal reports an enforcement result of one or more specific URSP rules each time, and/or the terminal reports each time an enforcement result of enforcing a URSP rule for a specific application APP or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

Optionally, the enforcement result of the URSP rule refers to a URSP rule enforced or used by the terminal for at least one APP or traffic of at least one APP.

Optionally, the reporting content includes at least one of the following:
a first URSP rule set, where the first URSP rule set includes at least one URSP rule;
a first APP set, where the first APP set includes at least one APP;
at least one time period; or
at least one terminal location.

Optionally, the first information indicates the at least one URSP rule in the first URSP rule set by carrying at least one of the following:
a URSP rule identifier, a traffic descriptor, a traffic descriptor precedence, a route selection descriptor, or a route selection descriptor precedence.

Optionally, the first information indicates the at least one APP in the first APP set by carrying at least one of the following:
an APP identifier, an application operating system identifier APP OSID, a source address or a source port number of an APP, a destination address or a destination port number accessed by an APP, a fully qualified domain name FQDN used or requested by an APP, or a data network name DNN used or requested by an APP.

Optionally, the first information indicates the at least one time period by carrying time information; and/or
the first information indicates the at least one terminal location by carrying at least one of the following:

UE location information or area of interest AOI information.

Optionally, the first information is carried in at least one of the following: at least one URSP rule; or
a policy section identifier PSI corresponding to at least one URSP rule.

Optionally, the reporting manner includes at least one of the following:
a first reporting manner, where the first reporting manner is as follows: after the terminal enforces a URSP rule for N times, the terminal reports, by using one piece of second information, enforcement results of the URSP rule enforced for N times, where N is an integer greater than 1;
a second reporting manner, where the second reporting manner is as follows: the terminal reports, by using one piece of second information, enforcement results of all URSP rules enforced by the terminal in one reporting period; or
a third reporting manner, where the third reporting manner is: reporting an enforcement result of a URSP rule by using a non-access stratum NAS message, where each NAS message includes enforcement results of a URSP rule enforced by the terminal for a plurality of times.

Optionally, the first information indicates the first reporting manner by carrying N, and N is used to indicate a quantity of times of accumulating URSP rules; or
the first information indicates the second reporting manner by carrying indication information of the reporting period.

Optionally, that after the terminal enforces a URSP rule for N times, the terminal reports, by using one piece of second information, enforcement results of the URSP rule enforced for N times includes:
in a case that the terminal enforces a first URSP rule for N times, the terminal reports, by using one piece of second information, enforcement results of the first URSP rule enforced for N times, where the first URSP rule is corresponding to only one URSP rule in the terminal; or
in a case that the terminal enforces a URSP rule for N times, the terminal reports, by using one piece of second information, enforcement results of the URSP rule enforced by the terminal for N times, where enforcement of the URSP rule for N times is not limited to enforcement of a same URSP rule.

Optionally, the second information is carried in an uplink NAS message or the second information is an uplink NAS message.

Optionally, the enforcement result of the URSP rule includes:
an identifier of the URSP rule;
enforcement frequency of the URSP rule;
APP information, where the APP information is used to indicate the terminal to enforce a URSP rule for an APP or APP traffic corresponding to the APP information, or the APP information is used to indicate an APP or APP traffic on the terminal corresponding to the enforcement result of the URSP rule reported by the terminal;
a traffic descriptor;
a route selection descriptor RSD;
a traffic descriptor precedence; and
an RSD precedence.

The enforcement result receiving apparatus can reduce transmission overheads.

The enforcement result receiving apparatus in this embodiment of this application may be an electronic device, for example, an electronic device with an operating system, or may be a component in the electronic device, for example, an integrated circuit or a chip. The electronic device may be a terminal or a network-side device.

The enforcement result receiving apparatus provided in this embodiment of this application can implement processes implemented in the method embodiment in FIG. 3, and achieve same technical effects. To avoid repetition, details are not described herein again.

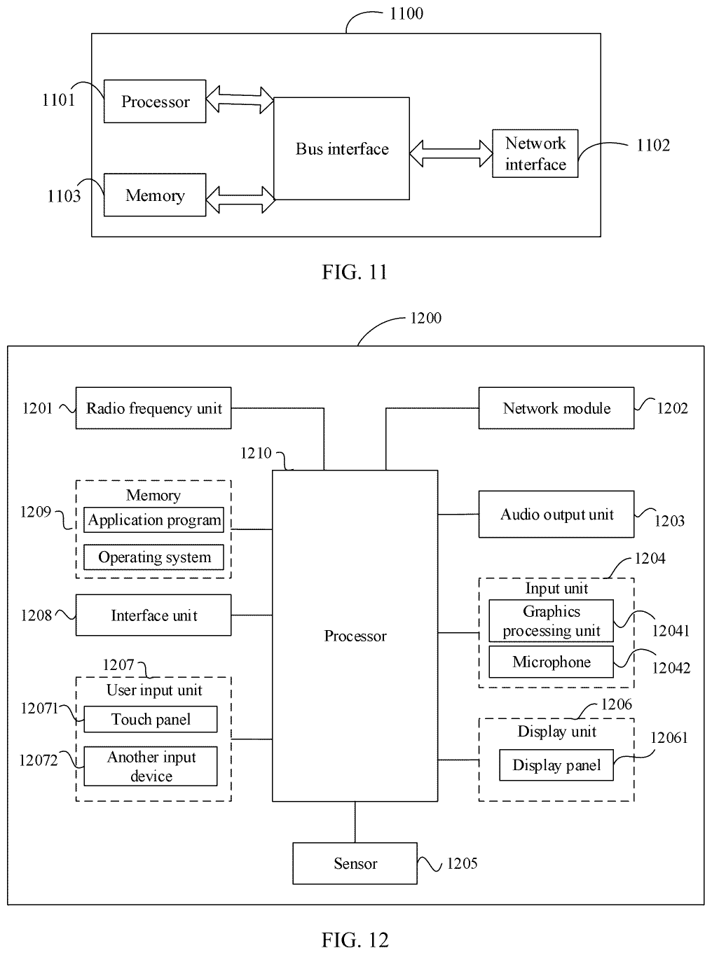

Optionally, as shown in FIG. 11, an embodiment of this application further provides a communication device 1100, including a processor 1101 and a memory 1102. The memory 1102 stores a program or instructions capable of running on the processor 1101. For example, when the communication device 1100 is a terminal, the program or the instructions are executed by the processor 1101 to implement the steps of the foregoing enforcement result reporting method embodiments, and the same technical effects can be achieved. When the communication device 1100 is a network-side device, the program or the instructions are executed by the processor 1101 to implement the steps of the foregoing enforcement result receiving method embodiments, and the same technical effects can be achieved. To avoid repetition, details are not described herein again.

An embodiment of this application further provides a communication device, including a processor and a communication interface, where the communication interface is configured to receive first information sent by a network-side device; and report an enforcement result of a UE route selection policy URSP rule according to the first information; where the first information is used to indicate at least one of the following: reporting content or a reporting manner; where in a case that the first information indicates the reporting content, the terminal reports an enforcement result of one or more specific URSP rules each time, and/or the terminal reports each time an enforcement result of enforcing a URSP rule for a specific application APP or APP traffic; or in a case that the first information indicates the reporting manner, the terminal reports each time enforcement results of a URSP rule enforced by the terminal for a plurality of times, or the terminal reports each time an enforcement result of a URSP rule enforced by the terminal in one reporting period. This embodiment of the communication device corresponds to the foregoing embodiment of the enforcement result reporting method. Each implementation process and implementation of the foregoing method embodiment may be applied to this embodiment of the communication device, and same technical effects can be achieved.

Specifically, FIG. 12 is a schematic structural diagram of hardware of a terminal for implementing an embodiment of this application.

The terminal 1200 includes but is not limited to at least some components of a radio frequency unit 1201, a network module 1202, an audio output unit 1203, an input unit 1204, a sensor 1205, a display unit 1206, a user input unit 1207, an interface unit 1208, a memory 1209, a processor 1210, and the like.

A person skilled in the art may understand that the terminal 1200 may further include a power supply (for example, a battery) that supplies power to each component. The power supply may be logically connected to the processor 1210 by using a power management system, to implement functions such as charging management, discharging management, and power consumption management through the power management system. The structure of the terminal shown in FIG. 12 does not constitute a limitation on the terminal. The terminal may include more or fewer components than those shown in the figure, or combine some components, or have different component arrangements. Details are not described herein again.

It should be understood that in this embodiment of this application, the input unit 1204 may include a Graphics Processing Unit (GPU) 12041 and a microphone 12042. The graphics processing unit 12041 processes image data of a still picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 or another input device 12072. The touch panel 12071 is also referred to as a touchscreen. The touch panel 12071 may include two parts: a touch detection apparatus and a touch controller. The another input device 12072 may include but is not limited to a physical keyboard, a function key (such as a volume control key or an on/off key), a trackball, a mouse, and an operating lever. Details are not described herein again.

In this embodiment of this application, after receiving downlink data from a network-side device, the radio frequency unit 1201 may transmit the downlink data to the processor 1210 for processing. In addition, the radio frequency unit 1201 may send uplink data to a network-side device. Generally, the radio frequency unit 1201 includes but is not limited to an antenna, an amplifier, a transceiver, a coupler, a low-noise amplifier, a duplexer, and the like.

The memory 1209 may be configured to store a software program or instructions and various types of data. The memory 1209 may mainly include a first storage area for storing a program or instructions and a second storage area for storing data. The first storage area may store an operating system, an application program or instructions required by at least one function (for example, a sound play function or an image play function), or the like. In addition, the memory 1209 may include a volatile memory or a non-volatile memory, or the memory 1209 may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1209 in this embodiment of this application includes but is not limited to these memories and any other suitable type of memory.

The processor 1210 may include one or more processing units. Optionally, the processor 1210 integrates an application processor and a modem processor. The application processor mainly processes operations related to an operating system, a user interface, an application program, and the like. The modem processor mainly processes a wireless communication signal, such as a baseband processor. It may be understood that, the foregoing modem processor may not be integrated into the processor 1210.

The radio frequency unit 1201 is configured to receive first information sent by a network-side device; and report an enforcement result of a UE route selection policy URSP rule according to the first information;
where the first information is used to indicate at least one of the following:
reporting content or a reporting manner;
where in a case that the first information indicates the reporting content, the terminal reports an enforcement result of one or more specific URSP rules each time, and/or the terminal reports each time an enforcement result of enforcing a URSP rule for a specific application APP or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

Optionally, the enforcement result of the URSP rule refers to a URSP rule enforced or used by the terminal for at least one APP or traffic of at least one APP.

Optionally, the reporting content includes at least one of the following:
a first URSP rule set, where the first URSP rule set includes at least one URSP rule;
a first APP set, where the first APP set includes at least one APP;
at least one time period; or
at least one terminal location.

Optionally, the reporting an enforcement result of a URSP rule according to the first information includes at least one of the following:
in a case that the reporting content includes the first URSP rule set, after the terminal enforces a URSP rule in the first URSP rule set, reporting an enforcement result of the URSP rule;
in a case that the reporting content includes the first APP set, after the terminal enforces a URSP rule for an APP or APP traffic that belongs to the first APP set, reporting an enforcement result of the URSP rule;
in a case that the reporting content includes the at least one time period, after the terminal enforces a URSP rule within a time indicated by the at least one time period, reporting an enforcement result of the URSP rule; or
in a case that the reporting content includes the at least one terminal location, after the terminal enforces a URSP rule at a terminal location in the at least one terminal location, reporting an enforcement result of the URSP rule.

Optionally, the first information indicates the at least one URSP rule in the first URSP rule set by carrying at least one of the following:
a URSP rule identifier, a traffic descriptor, a traffic descriptor precedence, a route selection descriptor, or a route selection descriptor precedence.

Optionally, the first information indicates the at least one APP in the first APP set by carrying at least one of the following:
an APP identifier, an application operating system identifier APP OSID, a source address or a source port number of an APP, a destination address or a destination port number accessed by an APP, a fully qualified domain name FQDN used or requested by an APP, or a data network name DNN used or requested by an APP.

Optionally, the first information indicates the at least one time period by carrying time information; and/or
the first information indicates the at least one terminal location by carrying at least one of the following:
UE location information or area of interest AOI information.

Optionally, the first information is carried in at least one of the following:
at least one URSP rule; or
a policy section identifier PSI corresponding to at least one URSP rule.

Optionally, the reporting an enforcement result of a URSP rule according to the first information includes at least one of the following:
in a case that the terminal receives a URSP rule carrying the first information, after the terminal completes enforcement of the URSP rule carrying the first information, reporting an enforcement result of the URSP rule; or
in a case that the terminal receives a PSI carrying the first information and one or more URSP rules are saved in or associated with the PSI, after the terminal completes enforcement of the URSP rule saved in or associated with the PSI, reporting an enforcement result of the URSP rule.

Optionally, the reporting manner includes at least one of the following:
a first reporting manner, where the first reporting manner is as follows: after the terminal enforces a URSP rule for N times, the terminal reports, by using one piece of second information, enforcement results of the URSP rule enforced for N times, where N is an integer greater than 1;
a second reporting manner, where the second reporting manner is as follows: the terminal reports, by using one piece of second information, enforcement results of all URSP rules enforced by the terminal in one reporting period; or
a third reporting manner, where the third reporting manner is: reporting an enforcement result of a URSP rule by using a non-access stratum NAS message, where each NAS message includes enforcement results of a URSP rule enforced by the terminal for a plurality of times.

Optionally, the first information indicates the first reporting manner by carrying N, and N is used to indicate a quantity of times of accumulating URSP rules; or
the first information indicates the second reporting manner by carrying indication information of the reporting period.

Optionally, the reporting an enforcement result of a URSP rule according to the first information includes at least one of the following:
in a case that the reporting manner includes the first reporting manner, saving an enforcement result of an enforced URSP rule, and when a quantity of times of enforcing the URSP rule by the terminal reaches N or more, reporting the saved enforcement result by using one piece of second information;
in a case that the reporting manner includes the second reporting manner, saving an enforcement result of an enforced URSP rule within a time indicated by a reporting period, and when an end time of the reporting period is reached, reporting the saved enforcement result by using one piece of second information; or
in a case that the reporting manner includes the third reporting manner, reporting an enforcement result of a URSP rule by using the NAS message, where the NAS message includes enforcement results of a URSP rule enforced by the terminal for a plurality of times or includes enforcement results of a plurality of URSP rules enforced by the terminal.

Optionally, that after the terminal enforces a URSP rule for N times, the terminal reports, by using one piece of second information, enforcement results of the URSP rule enforced for N times includes:
in a case that the terminal enforces a first URSP rule for N times, the terminal reports, by using one piece of second information, enforcement results of the first URSP rule enforced for N times, where the first URSP rule is corresponding to only one URSP rule in the terminal; or
in a case that the terminal enforces a URSP rule for N times, the terminal reports, by using one piece of second information, enforcement results of the URSP rule enforced by the terminal for N times, where enforcement of the URSP rule for N times is not limited to enforcement of a same URSP rule.

Optionally, the second information is carried in an uplink NAS message or the second information is an uplink NAS message.

Optionally, the enforcement result of the URSP rule includes:
an identifier of the URSP rule;
enforcement frequency of the URSP rule;
APP information, where the APP information is used to indicate the terminal to enforce a URSP rule for an APP or APP traffic corresponding to the APP information, or the APP information is used to indicate an APP or APP traffic on the terminal corresponding to the enforcement result of the URSP rule reported by the terminal;
a traffic descriptor;
a route selection descriptor RSD;
a traffic descriptor precedence; and
an RSD precedence.

The terminal can reduce transmission overheads.

An embodiment of this application further provides a communication device, including a processor and a communication interface, where the communication interface is configured to: send first information to a terminal; and receive an enforcement result of a UE route selection policy URSP rule reported by the terminal, where the first information is used to indicate at least one of the following: reporting content or a reporting manner; where in a case that the first information indicates the reporting content, the terminal reports an enforcement result of one or more specific URSP rules each time, and/or the terminal reports each time an enforcement result of enforcing a URSP rule for a specific application APP or APP traffic; or in a case that the first information indicates the reporting manner, the terminal reports each time enforcement results of a URSP rule enforced by the terminal for a plurality of times, or the terminal reports each time an enforcement result of a URSP rule enforced by the terminal in one reporting period. This embodiment of the communication device corresponds to the foregoing embodiment of the enforcement result receiving method. Each implementation process and implementation of the foregoing method embodiment may be applied to this embodiment of the communication device, and same technical effects can be achieved.

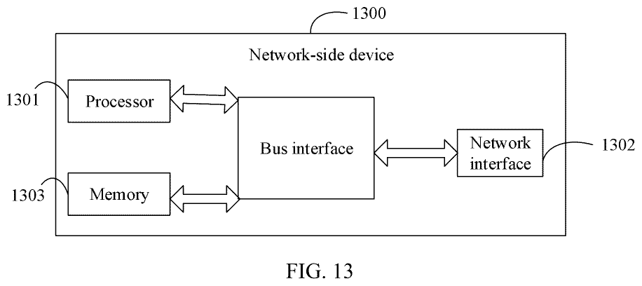

Specifically, an embodiment of this application further provides a network-side device. As shown in FIG. 13, the network-side device 1300 includes a processor 1301, a network interface 1302, and a memory 1303. The network interface 1302 is, for example, a Common Public Radio Interface (CPRI).

Specifically, the network-side device 1300 in this embodiment of the present invention further includes instructions or a program that is stored in the memory 1303 and that can be run on the processor 1301. The processor 1301 invokes the instructions or the program in the memory 1303 to perform the method performed by the modules shown in FIG. 10, and a same technical effect is achieved. To avoid repetition, details are not described herein again.

The network interface 1302 is configured to send first information to a terminal; and receive an enforcement result of a UE route selection policy URSP rule reported by the terminal;
where the first information is used to indicate at least one of the following:
reporting content or a reporting manner;
where in a case that the first information indicates the reporting content, the terminal reports an enforcement result of one or more specific URSP rules each time, and/or the terminal reports each time an enforcement result of enforcing a URSP rule for a specific application APP or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

Optionally, the enforcement result of the URSP rule refers to a URSP rule enforced or used by the terminal for at least one APP or traffic of at least one APP.

Optionally, the reporting content includes at least one of the following:
a first URSP rule set, where the first URSP rule set includes at least one URSP rule;
a first APP set, where the first APP set includes at least one APP;
at least one time period; or
at least one terminal location.

Optionally, the first information indicates the at least one URSP rule in the first URSP rule set by carrying at least one of the following:
a URSP rule identifier, a traffic descriptor, a traffic descriptor precedence, a route selection descriptor, or a route selection descriptor precedence.

Optionally, the first information indicates the at least one APP in the first APP set by carrying at least one of the following:
an APP identifier, an application operating system identifier APP OSID, a source address or a source port number of an APP, a destination address or a destination port number accessed by an APP, a fully qualified domain name FQDN used or requested by an APP, or a data network name DNN used or requested by an APP.

Optionally, the first information indicates the at least one time period by carrying time information; and/or
the first information indicates the at least one terminal location by carrying at least one of the following:
UE location information or area of interest AOI information.

Optionally, the first information is carried in at least one of the following:
at least one URSP rule; or
a policy section identifier PSI corresponding to at least one URSP rule.

Optionally, the reporting manner includes at least one of the following:
a first reporting manner, where the first reporting manner is as follows: after the terminal enforces a URSP rule for N times, the terminal reports, by using one piece of second information, enforcement results of the URSP rule enforced for N times, where N is an integer greater than 1;
a second reporting manner, where the second reporting manner is as follows: the terminal reports, by using one piece of second information, enforcement results of all URSP rules enforced by the terminal in one reporting period; or
a third reporting manner, where the third reporting manner is: reporting an enforcement result of a URSP rule by using a non-access stratum NAS message, where each NAS message includes enforcement results of a URSP rule enforced by the terminal for a plurality of times.

Optionally, the first information indicates the first reporting manner by carrying N, and N is used to indicate a quantity of times of accumulating URSP rules; or
the first information indicates the second reporting manner by carrying indication information of the reporting period.

Optionally, that after the terminal enforces a URSP rule for N times, the terminal reports, by using one piece of second information, enforcement results of the URSP rule enforced for N times includes:
in a case that the terminal enforces a first URSP rule for N times, the terminal reports, by using one piece of second information, enforcement results of the first URSP rule enforced for N times, where the first URSP rule is corresponding to only one URSP rule in the terminal; or
in a case that the terminal enforces a URSP rule for N times, the terminal reports, by using one piece of second information, enforcement results of the URSP rule enforced by the terminal for N times, where enforcement of the URSP rule for N times is not limited to enforcement of a same URSP rule.

Optionally, the second information is carried in an uplink NAS message or the second information is an uplink NAS message.

Optionally, the enforcement result of the URSP rule includes:
an identifier of the URSP rule;
enforcement frequency of the URSP rule;
APP information, where the APP information is used to indicate the terminal to enforce a URSP rule for an APP or APP traffic corresponding to the APP information, or the APP information is used to indicate an APP or APP traffic on the terminal corresponding to the enforcement result of the URSP rule reported by the terminal;
a traffic descriptor;
a route selection descriptor RSD;
a traffic descriptor precedence; and
an RSD precedence.

The network-side device can reduce transmission overheads.

An embodiment of this application further provides a readable storage medium, where the readable storage medium stores a program or instructions, and the program or the instructions are executed by a processor to implement the steps of the enforcement result reporting method or the enforcement result receiving method provided in the embodiments of this application.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement various processes in the foregoing embodiments of the enforcement result reporting method and the enforcement result receiving method, and a same technical effect can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement various processes in the foregoing embodiments of the enforcement result reporting method and the enforcement result receiving method, and a same technical effect can be achieved. To avoid repetition, details are not described herein again.

An embodiment of this application further provides an enforcement result reporting apparatus, where the apparatus includes:
an enforcement module, configured to enforce a second URSP rule, where the second URSP rule includes a plurality of traffic descriptor components, and the plurality of traffic descriptor components include a first traffic descriptor component and a second traffic descriptor component; and
a reporting module, configured to report an enforcement result of the second URSP rule according to a first reporting rule, where the first reporting rule includes at least one of the following:
reporting an enforcement result of the first traffic descriptor component, and not reporting an enforcement result of the second traffic descriptor component;
reporting enforcement results of all traffic descriptor components in the second URSP rule;
not reporting enforcement results of all traffic descriptor components in the second URSP rule;
reporting a rule precedence (rule precedence) of the second URSP rule;
not reporting a rule precedence of the second URSP rule;
reporting a rule precedence of the second URSP rule including the second traffic descriptor component; or
not reporting a rule precedence of the second URSP rule including the second traffic descriptor component.

Optionally, the apparatus further includes:
a receiving module, where the receiving module is configured to receive a second reporting rule or the first reporting rule, where the second reporting rule includes at least one of the following:
reporting an enforcement result of the first traffic descriptor component, and not reporting an enforcement result of the second traffic descriptor component;
reporting enforcement results of all traffic descriptor components in the second URSP rule;
not reporting enforcement results of all traffic descriptor components in the second URSP rule;
reporting a rule precedence of the second URSP rule;
reporting a rule precedence of the second URSP rule including the second traffic descriptor component; or
not reporting a rule precedence of the second URSP rule including the second traffic descriptor component.

An embodiment of this application further provides a terminal, including a processor, a memory, and a program or instructions stored in the memory and capable of running on the processor. The program or the instructions are executed by the processor to implement:
enforcing a second URSP rule, where the second URSP rule includes a plurality of traffic descriptor components, and the plurality of traffic descriptor components include a first traffic descriptor component and a second traffic descriptor component; and
reporting an enforcement result of the second URSP rule according to a first reporting rule;
where the first reporting rule includes at least one of the following:
reporting an enforcement result of the first traffic descriptor component, and not reporting an enforcement result of the second traffic descriptor component;
reporting enforcement results of all traffic descriptor components in the second URSP rule;
not reporting enforcement results of all traffic descriptor components in the second URSP rule;
reporting a rule precedence (rule precedence) of the second URSP rule;
not reporting a rule precedence of the second URSP rule;
reporting a rule precedence of the second URSP rule including the second traffic descriptor component; or
not reporting a rule precedence of the second URSP rule including the second traffic descriptor component.

An embodiment of this application further provides a readable storage medium, where the readable storage medium stores a program or instructions, and the program or the instructions are executed by the processor to implement:
enforcing a second URSP rule, where the second URSP rule includes a plurality of traffic descriptor components, and the plurality of traffic descriptor components include a first traffic descriptor component and a second traffic descriptor component; and
reporting an enforcement result of the second URSP rule according to a first reporting rule;
where the first reporting rule includes at least one of the following:
reporting an enforcement result of the first traffic descriptor component, and not reporting an enforcement result of the second traffic descriptor component;
reporting enforcement results of all traffic descriptor components in the second URSP rule;
not reporting enforcement results of all traffic descriptor components in the second URSP rule;
reporting a rule precedence (rule precedence) of the second URSP rule;
not reporting a rule precedence of the second URSP rule;
reporting a rule precedence of the second URSP rule including the second traffic descriptor component; or
not reporting a rule precedence of the second URSP rule including the second traffic descriptor component.

An embodiment of this application further provides an enforcement result reporting system, including a terminal and a network-side device, where the terminal may be configured to perform the steps of the enforcement result reporting method provided in embodiments of this application, and the network-side device may be configured to perform the steps of the enforcement result receiving method provided in embodiments of this application.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. An enforcement result reporting method, comprising:
receiving, by a terminal, first information sent by a network-side device, wherein the first information is a reporting indication, and the first information in carried by at least one UE route selection policy (URSP) rule; and
reporting, by the terminal, an enforcement result of a URSP rule according to the first information; wherein
the reporting, by the terminal, an enforcement result of a URSP rule according to the first information comprises:
in a case that the terminal receives a URSP rule carrying the first information, after the terminal completes enforcement of the URSP rule carrying the first information, reporting, by the terminal, an enforcement result of the URSP rule.

2. The method according to claim 1, wherein the first information is used to indicate at least one of the following:
reporting content or a reporting manner;
wherein in a case that the first information indicates the reporting content, the terminal reports an enforcement result of one or more specific URSP rules each time, and/or the terminal reports each time an enforcement result of enforcing a URSP rule for a specific application (APP) or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

3. The method according to claim 1, wherein
the enforcement result of the URSP rule refers to a URSP rule enforced or used by the terminal for at least one APP or traffic of at least one APP.

4. The method according to claim 2, wherein the reporting content comprises at least one of the following:
a first URSP rule set, wherein the first URSP rule set comprises at least one URSP rule;
a first APP set, wherein the first APP set comprises at least one APP;
at least one time period; or
at least one terminal location.

5. The method according to claim 4, wherein the reporting, by the terminal, an enforcement result of a URSP rule according to the first information comprises at least one of the following:
in a case that the reporting content comprises the first URSP rule set, after the terminal enforces a URSP rule in the first URSP rule set, reporting, by the terminal, an enforcement result of the URSP rule;
in a case that the reporting content comprises the first APP set, after the terminal enforces a URSP rule for an APP or APP traffic that belongs to the first APP set, reporting, by the terminal, an enforcement result of the URSP rule;
in a case that the reporting content comprises the at least one time period, after the terminal enforces a URSP rule within a time indicated by the at least one time period, reporting, by the terminal, an enforcement result of the URSP rule; or
in a case that the reporting content comprises the at least one terminal location, after the terminal enforces a URSP rule at a terminal location in the at least one terminal location, reporting, by the terminal, an enforcement result of the URSP rule.

6. The method according to claim 1, wherein the URSP rule carrying the first information further carries a first traffic descriptor component, the first traffic descriptor component comprising a connection capability.

7. The method according to claim 6, wherein the reporting, by the terminal, an enforcement result of the URSP rule comprises:
reporting, by the terminal, an enforcement result of the first traffic descriptor component.

8. The method according to claim 2, wherein the reporting manner comprises at least one of the following:
a first reporting manner, wherein the first reporting manner is as follows: after the terminal enforces a URSP rule for N times, the terminal reports, by using one piece of second information, enforcement results of the URSP rule enforced for N times, wherein N is an integer greater than 1;
a second reporting manner, wherein the second reporting manner is as follows: the terminal reports, by using one piece of second information, enforcement results of all URSP rules enforced by the terminal in one reporting period; or
a third reporting manner, wherein the third reporting manner is: reporting an enforcement result of a URSP rule by using a non-access stratum NAS message, wherein each NAS message comprises enforcement results of a URSP rule enforced by the terminal for a plurality of times.

9. The method according to claim 8, wherein the first information indicates the first reporting manner by carrying N, and N is used to indicate a quantity of times of accumulating URSP rules; or
the first information indicates the second reporting manner by carrying indication information of the reporting period.

10. The method according to claim 1, wherein the enforcement result of the URSP rule comprises:
an identifier of the URSP rule;
enforcement frequency of the URSP rule;
APP information, wherein the APP information is used to indicate the terminal to enforce a URSP rule for an APP or APP traffic corresponding to the APP information, or the APP information is used to indicate an APP or APP traffic on the terminal corresponding to the enforcement result of the URSP rule reported by the terminal;
a traffic descriptor;
a route selection descriptor RSD;
a traffic descriptor precedence; and
an RSD precedence.

11. The method according to claim 4, wherein the first URSP rule set comprises a URSP rule carrying the first information.

12. An enforcement result receiving method, comprising:
sending, by a network-side device, first information to a terminal, wherein the first information is a reporting indication, and the first information in carried by at least one UE route selection policy (URSP) rule; and
receiving, by the network-side device, an enforcement result of a URSP rule reported by the terminal; wherein the enforcement result of the URSP rule reported by the terminal is an enforcement result of the URSP rule carrying the first information.

13. The method according to claim 12, wherein the first information is used to indicate at least one of the following:
reporting content or a reporting manner;
wherein in a case that the first information indicates the reporting content, the terminal reports an enforcement result of one or more specific URSP rules each time, and/or the terminal reports each time an enforcement result of enforcing a URSP rule for a specific application (APP) or APP traffic; or
in a case that the first information indicates the reporting manner, the terminal reports each time enforcement results of a URSP rule enforced by the terminal for a plurality of times, or the terminal reports each time an enforcement result of a URSP rule enforced by the terminal in one reporting period.

14. The method according to claim 12, wherein
the enforcement result of the URSP rule refers to a URSP rule enforced or used by the terminal for at least one APP or traffic of at least one APP.

15. The method according to claim 13, wherein the reporting content comprises at least one of the following:
a first URSP rule set, wherein the first URSP rule set comprises at least one URSP rule;
a first APP set, wherein the first APP set comprises at least one APP;
at least one time period; or
at least one terminal location.

16. The method according to claim 12, wherein the URSP rule carrying the first information further carries a first traffic descriptor component, the first traffic descriptor component comprising a connection capability.

17. The method according to claim 16, wherein the receiving, by the network-side device, an enforcement result of a URSP rule reported by the terminal comprises:
receiving, by the network-side device, an enforcement result of the first traffic descriptor component reported by the terminal.

18. A terminal, comprising a processor and a memory, wherein the memory stores a program or instructions capable of running on the processor, and the program or instructions are executed by the processor to implement the steps of an enforcement result reporting method, wherein the enforcement result reporting method comprises:
receiving first information sent by a network-side device, wherein the first information is a reporting indication, and the first information in carried by at least one UE route selection policy (URSP) rule; and
reporting an enforcement result of a URSP rule according to the first information; wherein
the reporting an enforcement result of a URSP rule according to the first information comprises:
in a case of receiving a URSP rule carrying the first information, after enforcement of the URSP rule carrying the first information is completed, reporting an enforcement result of the URSP rule.

19. A network-side device, comprising a processor and a memory, wherein the memory stores a program or instructions capable of running on the processor, and the program or the instructions are executed by the processor to implement the steps of the enforcement result receiving method according to claim 12.

20. A readable storage medium, wherein a program or instructions are stored on the readable storage medium, and the program or the instructions are executed by a processor to implement the steps of the enforcement result reporting method according to claim 1.
